(19) United States
(12) Patent Application Publication
(10) Pub. No.: US 2019/0079934 A1
(43) Pub. Date: Mar. 14, 2019

(54) Snippet Generation for Content Search on Online Social Networks

(71) Applicant: Facebook, Inc., Menlo Park, CA (US)

(72) Inventors: Zhen Liao, Sunnyvale, CA (US); Han Jiang, Mountain View, CA (US); Yi Zeng, Menlo Park, CA (US)

(21) Appl. No.: 15/699,568

(22) Filed: Sep. 8, 2017

(51) Int. Cl. G06F 17/30

(52) U.S. Cl. CPC G06F 17/3053; G06F 17/30554; G06F 17/30867

(57) ABSTRACT

In one embodiment, a method includes receiving a search query from a client system. The method includes identifying, by a search-engine server, multiple content objects matching the search query, wherein each content object includes a plurality of content tokens. The method includes determining, by a snippet generator, for each content object matching the search query, a snippet including multiple content tokens from the content object, the snippet being determined based on a token score associated with each content token. The method includes ranking each identified content object based on a content-object ranking-score calculated for the content object and a snippet ranking-score calculated for the snippet of the respective content object. The method includes sending, to the client system, instructions for presenting multiple search-results including a reference to a content object and a preview of the content of the respective content object including the snippet associated with the content object.

### TECHNICAL FIELD

This disclosure generally relates to social graphs and performing searches for objects within a social-networking environment.

### BACKGROUND

A social-networking system, which may include a social-networking website, may enable its users (such as persons or organizations) to interact with it and with each other through it. The social-networking system may, with input from a user, create and store in the social-networking system a user profile associated with the user. The user profile may include demographic information, communication-channel information, and information on personal interests of the user. The social-networking system may also, with input from a user, create and store a record of relationships of the user with other users of the social-networking system, as well as provide services (e.g. wall posts, photo-sharing, event organization, messaging, games, or advertisements) to facilitate social interaction between or among users.

The social-networking system may send over one or more networks content or messages related to its services to a mobile or other computing device of a user. A user may also install software applications on a mobile or other computing device of the user for accessing a user profile of the user and other data within the social-networking system . The social-networking system may generate a personalized set of content objects to display to a user, such as a newsfeed of aggregated stories of other users connected to the user.

Social-graph analysis views social relationships in terms of network theory consisting of nodes and edges. Nodes represent the individual actors within the networks, and edges represent the relationships between the actors. The resulting graph-based structures are often very complex. There can be many types of nodes and many types of edges for connecting nodes. In its simplest form, a social graph is a map of all of the relevant edges between all the nodes being studied.

### SUMMARY OF PARTICULAR EMBODIMENTS

In particular embodiments, the social-networking system may identify and rank content objects matching a search query based on snippets, and snippet-related ranking factors, extracted from the content objects. A snippet is a segment of a content object determined to be representative of a content object and extracted from the content object. As an example, a snippet may be a text segment extracted from a post-type object. A snippet may be shown to a user as the user is viewing search results to give the user an idea of the content of the content object corresponding to each search result. Snippets may be selected for each type of content object, agnostic of the actual content therein. Snippets may also be selected based on the particular content of each content object resulting in higher quality snippets. With the improved quality of snippets, the characteristics and interaction history of each snippet may be used to improve rankings of search results for the snippets' corresponding content objects. Search results generated based on the improved snippets and snippet-related ranking features may more clearly demonstrate to a user why a particular post is relevant to their search query. This may improve user engagement and satisfaction with search queries in general. This may also reduce the strain on the social-networking system. Previously, a user accessing a search results page had to select a search result, causing the social-networking system to serve the underlying content object, before the user could determine the relevance of the search result. If the user was not satisfied with the content object, the user must return to the search results page, served by the social-networking system, and select an additional search result. Improved snippets may allow a user to more effectively determine the quality or relevance of a search result before the full content object is loaded, increasing the amount of time the user spends on the content object, and reducing the number of content objects served by the social-networking system and the number of additional search result page loads. The social-networking system may rank the content objects based on factors related to each content object, such as the author of the content object, and factors related to the to the snippet generated for each content object, such as how often the n-grams of the search query are used. The social-networking system may generate search results comprising the content objects and related snippets and present the search results to the searching user.

The embodiments disclosed herein are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates an example network environment associated with a social-networking system.

FIG. 2 illustrates an example social graph.

FIG. 3 illustrates an example partitioning for storing objects of a social-networking system.

FIG. 4 illustrates an example configuration of a snippet generation module.

FIG. 5 illustrates an example content object.

FIG. 6 illustrates an example configuration of a system for generating ranking-scores.

FIG. 7 illustrates examples search results comprising snippets.

FIG. 8 illustrates an example method 800 for generating search results corresponding to content objects comprising snippets associated with each content object.

FIG. 9 illustrates an example computer system.

### DESCRIPTION OF EXAMPLE EMBODIMENTS

### System Overview

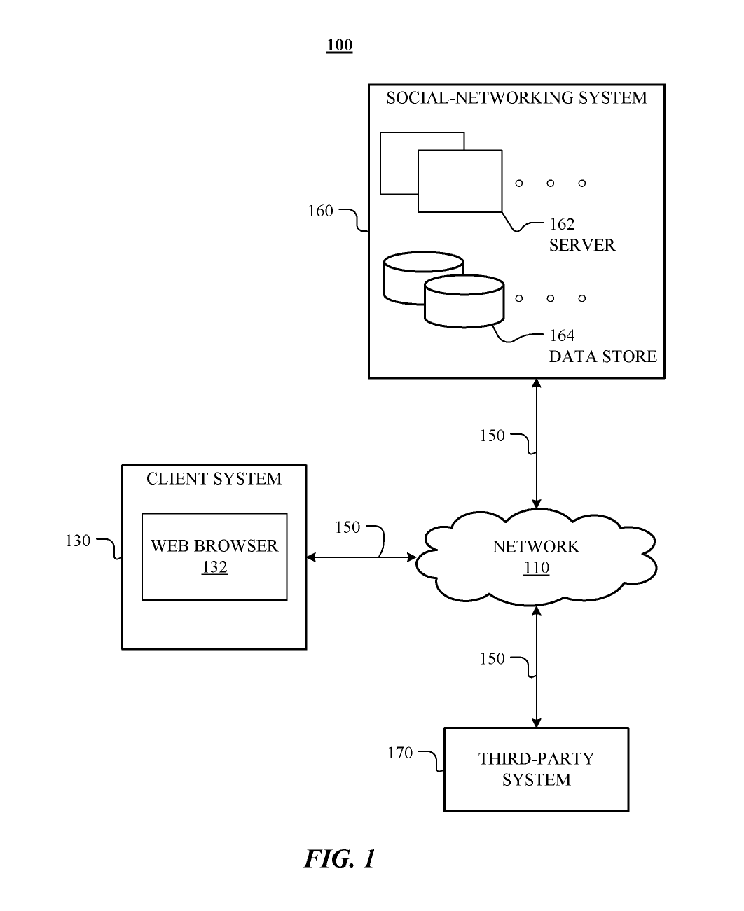

FIG. 1 illustrates an example network environment 100 associated with a social-networking system 160. Network environment 100 includes a client system 130, a social-networking system 160, and a third-party system 170 connected to each other by a network 110. Although FIG. 1 illustrates a particular arrangement of a client system 130, a social-networking system 160, a third-party system 170, and a network 110, this disclosure contemplates any suitable arrangement of a client system 130, a social-networking system 160, a third-party system 170, and a network 110. As an example and not by way of limitation, two or more of a client system 130, a social-networking system 160, and a third-party system 170 may be connected to each other directly, bypassing a network 110. As another example, two or more of a client system 130, a social-networking system 160, and a third-party system 170 may be physically or logically co-located with each other in whole or in part. Moreover, although FIG. 1 illustrates a particular number of client systems 130, social-networking system 160s 160, third-party systems 170, and networks 110, this disclosure contemplates any suitable number of client systems 130, social-networking system 160s 160, third-party systems 170, and networks 110. As an example and not by way of limitation, network environment 100 may include multiple client systems 130, social-networking system 160s 160, third-party systems 170, and networks 110.

This disclosure contemplates any suitable network 110. As an example and not by way of limitation, one or more portions of a network 110 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. A network 110 may include one or more networks 110.

Links 150 may connect a client system 130, a social-networking system 160, and a third-party system 170 to a communication network 110 or to each other. This disclosure contemplates any suitable links 150. In particular embodiments, one or more links 150 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 150 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout a network environment 100. One or more first links 150 may differ in one or more respects from one or more second links 150.

In particular embodiments, a client system 130 may be an electronic device including hardware, software, or embedded logic components or a combination of two or more such components and capable of carrying out the appropriate functionalities implemented or supported by a client system 130. As an example and not by way of limitation, a client system 130 may include a computer system such as a desktop computer, notebook or laptop computer, netbook, a tablet computer, e-book reader, GPS device, camera, personal digital assistant (PDA), handheld electronic device, cellular telephone, smartphone, other suitable electronic device, or any suitable combination thereof. This disclosure contemplates any suitable client systems 130. A client system 130 may enable a network user at a client system 130 to access a network 110. A client system 130 may enable its user to communicate with other users at other client systems 130.

In particular embodiments, a client system 130 may include a web browser 132, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at a client system 130 may enter a Uniform Resource Locator (URL) or other address directing a web browser 132 to a particular server (such as server 162, or a server associated with a third-party system 170), and the web browser 132 may generate a Hyper Text Transfer Protocol (HTTP) request and communicate the HTTP request to server. The server may accept the HTTP request and communicate to a client system 130 one or more Hyper Text Markup Language (HTML) files responsive to the HTTP request. The client system 130 may render a web interface (e.g. a webpage) based on the HTML files from the server for presentation to the user. This disclosure contemplates any suitable source files. As an example and not by way of limitation, a web interface may be rendered from HTML files, Extensible Hyper Text Markup Language (XHTML) files, or Extensible Markup Language (XML) files, according to particular needs. Such interfaces may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a web interface encompasses one or more corresponding source files (which a browser may use to render the web interface) and vice versa, where appropriate.

In particular embodiments, the social-networking system 160 may be a network-addressable computing system that can host an online social network. The social-networking system 160 may generate, store, receive, and send social-networking data, such as, for example, user-profile data, concept-profile data, social-graph information, or other suitable data related to the online social network. The social-networking system 160 may be accessed by the other components of network environment 100 either directly or via a network 110. As an example and not by way of limitation, a client system 130 may access the social-networking system 160 using a web browser 132, or a native application associated with the social-networking system 160 (e.g., a mobile social-networking application, a messaging application, another suitable application, or any combination thereof) either directly or via a network 110. In particular embodiments, the social-networking system 160 may include one or more servers 162. Each server 162 may be a unitary server or a distributed server spanning multiple computers or multiple datacenters. Servers 162 may be of various types, such as, for example and without limitation, web server, news server, mail server, message server, advertising server, file server, application server, exchange server, database server, proxy server, another server suitable for performing functions or processes described herein, or any combination thereof. In particular embodiments, each server 162 may include hardware, software, or embedded logic components or a combination of two or more such components for carrying out the appropriate functionalities implemented or supported by server 162. In particular embodiments, the social-networking system 160 may include one or more data stores 164. Data stores 164 may be used to store various types of information. In particular embodiments, the information stored in data stores 164 may be organized according to specific data structures. In particular embodiments, each data store 164 may be a relational, columnar, correlation, or other suitable database. Although this disclosure describes or illustrates particular types of databases, this disclosure contemplates any suitable types of databases. Particular embodiments may provide interfaces that enable a client system 130, a social-networking system 160, or a third-party system 170 to manage, retrieve, modify, add, or delete, the information stored in data store 164.

In particular embodiments, the social-networking system 160 may store one or more social graphs in one or more data stores 164. In particular embodiments, a social graph may include multiple nodes—which may include multiple user nodes (each corresponding to a particular user) or multiple concept nodes (each corresponding to a particular concept)—and multiple edges connecting the nodes. The social-networking system 160 may provide users of the online social network the ability to communicate and interact with other users. In particular embodiments, users may join the online social network via the social-networking system 160 and then add connections (e.g., relationships) to a number of other users of the social-networking system 160 whom they want to be connected to. Herein, the term “friend” may refer to any other user of the social-networking system 160 with whom a user has formed a connection, association, or relationship via the social-networking system 160.

In particular embodiments, the social-networking system 160 may provide users with the ability to take actions on various types of items or objects, supported by the social-networking system 160. As an example and not by way of limitation, the items and objects may include groups or social networks to which users of the social-networking system 160 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in the social-networking system 160 or by an external system of a third-party system 170, which is separate from the social-networking system 160 and coupled to the social-networking system 160 via a network 110.

In particular embodiments, the social-networking system 160 may be capable of linking a variety of entities. As an example and not by way of limitation, the social-networking system 160 may enable users to interact with each other as well as receive content from third-party systems 170 or other entities, or to allow users to interact with these entities through an application programming interfaces (API) or other communication channels.

In particular embodiments, a third-party system 170 may include one or more types of servers, one or more data stores, one or more interfaces, including but not limited to APIs, one or more web services, one or more content sources, one or more networks, or any other suitable components, e.g., that servers may communicate with. A third-party system 170 may be operated by a different entity from an entity operating the social-networking system 160. In particular embodiments, however, the social-networking system 160 and third-party systems 170 may operate in conjunction with each other to provide social-networking services to users of the social-networking system 160 or third-party systems 170. In this sense, the social-networking system 160 may provide a platform, or backbone, which other systems, such as third-party systems 170, may use to provide social-networking services and functionality to users across the Internet.

In particular embodiments, a third-party system 170 may include a third-party content object provider. A third-party content object provider may include one or more sources of content objects, which may be communicated to a client system 130. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, the social-networking system 160 also includes user-generated content objects, which may enhance a user's interactions with the social-networking system 160. User-generated content may include anything a user can add, upload, send, or “post” to the social-networking system 160. As an example and not by way of limitation, a user communicates posts to the social-networking system 160 from a client system 130. Posts may include data such as status updates or other textual data, location information, photos, videos, links, music or other similar data or media. Content may also be added to the social-networking system 160 by a third-party through a “communication channel,” such as a newsfeed or stream.

In particular embodiments, the social-networking system 160 may include a variety of servers, sub-systems, programs, modules, logs, and data stores. In particular embodiments, the social-networking system 160 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. The social-networking system 160 may also include suitable components such as network interfaces, security mechanisms, load balancers, failover servers, management-and-network-operations consoles, other suitable components, or any suitable combination thereof. In particular embodiments, the social-networking system 160 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking the social-networking system 160 to one or more client systems 130 or one or more third-party systems 170 via a network 110. The web server may include a mail server or other messaging functionality for receiving and routing messages between the social-networking system 160 and one or more client systems 130. An API-request server may allow a third-party system 170 to access information from the social-networking system 160 by calling one or more APIs. An action logger may be used to receive communications from a web server about a user's actions on or off the social-networking system 160. In conjunction with the action log, a third-party-content-object log may be maintained of user exposures to third-party-content objects. A notification controller may provide information regarding content objects to a client system 130. Information may be pushed to a client system 130 as notifications, or information may be pulled from a client system 130 responsive to a request received from a client system 130. Authorization servers may be used to enforce one or more privacy settings of the users of the social-networking system 160. A privacy setting of a user determines how particular information associated with a user can be shared. The authorization server may allow users to opt in to or opt out of having their actions logged by the social-networking system 160 or shared with other systems (e.g., a third-party system 170), such as, for example, by setting appropriate privacy settings. Third-party-content-object stores may be used to store content objects received from third parties, such as a third-party system 170. Location stores may be used for storing location information received from client systems 130 associated with users. Advertisement-pricing modules may combine social information, the current time, location information, or other suitable information to provide relevant advertisements, in the form of notifications, to a user.

### Social Graphs

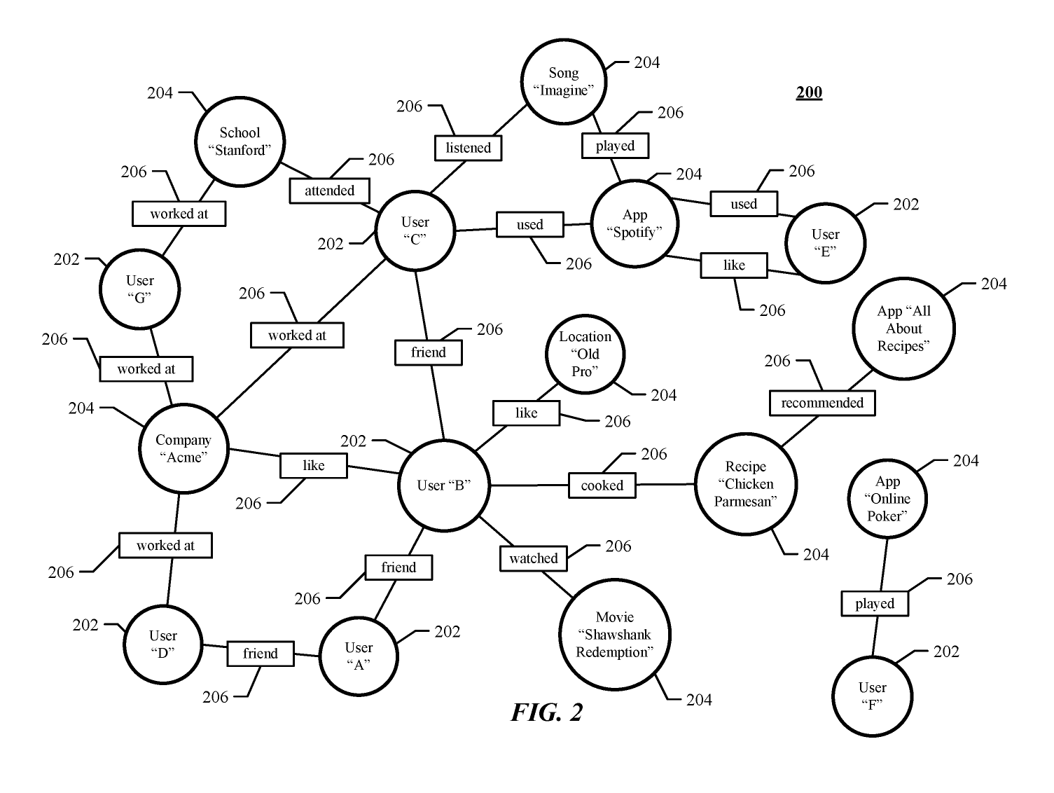

FIG. 2 illustrates an example social graph 200. In particular embodiments, the social-networking system 160 may store one or more social graphs 200 in one or more data stores. In particular embodiments, the social graph 200 may include multiple nodes—which may include multiple user nodes 202 or multiple concept nodes 204—and multiple edges 206 connecting the nodes. The example social graph 200 illustrated in FIG. 2 is shown, for didactic purposes, in a two-dimensional visual map representation. In particular embodiments, a social-networking system 160, a client system 130, or a third-party system 170 may access the social graph 200 and related social-graph information for suitable applications. The nodes and edges of the social graph 200 may be stored as data objects, for example, in a data store (such as a social-graph database). Such a data store may include one or more searchable or queryable indexes of nodes or edges of the social graph 200.

In particular embodiments, a user node 202 may correspond to a user of the social-networking system 160. As an example and not by way of limitation, a user may be an individual (human user), an entity (e.g., an enterprise, business, or third-party application), or a group (e.g., of individuals or entities) that interacts or communicates with or over the social-networking system 160. In particular embodiments, when a user registers for an account with the social-networking system 160, the social-networking system 160 may create a user node 202 corresponding to the user, and store the user node 202 in one or more data stores. Users and user nodes 202 described herein may, where appropriate, refer to registered users and user nodes 202 associated with registered users. In addition or as an alternative, users and user nodes 202 described herein may, where appropriate, refer to users that have not registered with the social-networking system 160. In particular embodiments, a user node 202 may be associated with information provided by a user or information gathered by various systems, including the social-networking system 160. As an example and not by way of limitation, a user may provide his or her name, profile picture, contact information, birth date, sex, marital status, family status, employment, education background, preferences, interests, or other demographic information. In particular embodiments, a user node 202 may be associated with one or more data objects corresponding to information associated with a user. In particular embodiments, a user node 202 may correspond to one or more web interfaces.

In particular embodiments, a concept node 204 may correspond to a concept. As an example and not by way of limitation, a concept may correspond to a place (such as, for example, a movie theater, restaurant, landmark, or city); a website (such as, for example, a website associated with the social-networking system 160 or a third-party website associated with a web-application server); an entity (such as, for example, a person, business, group, sports team, or celebrity); a resource (such as, for example, an audio file, video file, digital photo, text file, structured document, or application) which may be located within the social-networking system 160 or on an external server, such as a web-application server; real or intellectual property (such as, for example, a sculpture, painting, movie, game, song, idea, photograph, or written work); a game; an activity; an idea or theory; another suitable concept; or two or more such concepts. A concept node 204 may be associated with information of a concept provided by a user or information gathered by various systems, including the social-networking system 160. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 204 may be associated with one or more data objects corresponding to information associated with concept node 204. In particular embodiments, a concept node 204 may correspond to one or more web interfaces.

In particular embodiments, a node in the social graph 200 may represent or be represented by a web interface (which may be referred to as a “profile interface”). Profile interfaces may be hosted by or accessible to the social-networking system 160. Profile interfaces may also be hosted on third-party websites associated with a third-party system 170. As an example and not by way of limitation, a profile interface corresponding to a particular external web interface may be the particular external web interface and the profile interface may correspond to a particular concept node 204. Profile interfaces may be viewable by all or a selected subset of other users. As an example and not by way of limitation, a user node 202 may have a corresponding user-profile interface in which the corresponding user may add content, make declarations, or otherwise express himself or herself. As another example and not by way of limitation, a concept node 204 may have a corresponding concept-profile interface in which one or more users may add content, make declarations, or express themselves, particularly in relation to the concept corresponding to concept node 204.

In particular embodiments, a concept node 204 may represent a third-party web interface or resource hosted by a third-party system 170. The third-party web interface or resource may include, among other elements, content, a selectable or other icon, or other interactable object (which may be implemented, for example, in JavaScript, AJAX, or PHP codes) representing an action or activity. As an example and not by way of limitation, a third-party web interface may include a selectable icon such as “like,” “check-in,” “eat,” “recommend,” or another suitable action or activity. A user viewing the third-party web interface may perform an action by selecting one of the icons (e.g., “check-in”), causing a client system 130 to send to the social-networking system 160 a message indicating the user's action. In response to the message, the social-networking system 160 may create an edge (e.g., a check-in-type edge) between a user node 202 corresponding to the user and a concept node 204 corresponding to the third-party web interface or resource and store edge 206 in one or more data stores.

In particular embodiments, a pair of nodes in the social graph 200 may be connected to each other by one or more edges 206. An edge 206 connecting a pair of nodes may represent a relationship between the pair of nodes. In particular embodiments, an edge 206 may include or represent one or more data objects or attributes corresponding to the relationship between a pair of nodes. As an example and not by way of limitation, a first user may indicate that a second user is a “friend” of the first user. In response to this indication, the social-networking system 160 may send a “friend request” to the second user. If the second user confirms the “friend request,” the social-networking system 160 may create an edge 206 connecting the first user's user node 202 to the second user's user node 202 in the social graph 200 and store edge 206 as social-graph information in one or more of data stores 164. In the example of FIG. 2, the social graph 200 includes an edge 206 indicating a friend relation between user nodes 202 of user “A” and user “B” and an edge indicating a friend relation between user nodes 202 of user “C” and user “B.” Although this disclosure describes or illustrates particular edges 206 with particular attributes connecting particular user nodes 202, this disclosure contemplates any suitable edges 206 with any suitable attributes connecting user nodes 202. As an example and not by way of limitation, an edge 206 may represent a friendship, family relationship, business or employment relationship, fan relationship (including, e.g., liking, etc.), follower relationship, visitor relationship (including, e.g., accessing, viewing, checking-in, sharing, etc.), sub scriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in the social graph 200 by one or more edges 206.

In particular embodiments, an edge 206 between a user node 202 and a concept node 204 may represent a particular action or activity performed by a user associated with user node 202 toward a concept associated with a concept node 204. As an example and not by way of limitation, as illustrated in FIG. 2, a user may “like,” “attended,” “played,” “listened,” “cooked,” “worked at,” or “watched” a concept, each of which may correspond to an edge type or subtype. A concept-profile interface corresponding to a concept node 204 may include, for example, a selectable “check in” icon (such as, for example, a clickable “check in” icon) or a selectable “add to favorites” icon. Similarly, after a user clicks these icons, the social-networking system 160 may create a “favorite” edge or a “check in” edge in response to a user's action corresponding to a respective action. As another example and not by way of limitation, a user (user “C”) may listen to a particular song (“Imagine”) using a particular application (SPOTIFY, which is an online music application). In this case, the social-networking system 160 may create a “listened” edge 206 and a “used” edge (as illustrated in FIG. 2) between user nodes 202 corresponding to the user and concept nodes 204 corresponding to the song and application to indicate that the user listened to the song and used the application. Moreover, the social-networking system 160 may create a “played” edge 206 (as illustrated in FIG. 2) between concept nodes 204 corresponding to the song and the application to indicate that the particular song was played by the particular application. In this case, “played” edge 206 corresponds to an action performed by an external application (SPOTIFY) on an external audio file (the song “Imagine”). Although this disclosure describes particular edges 206 with particular attributes connecting user nodes 202 and concept nodes 204, this disclosure contemplates any suitable edges 206 with any suitable attributes connecting user nodes 202 and concept nodes 204. Moreover, although this disclosure describes edges between a user node 202 and a concept node 204 representing a single relationship, this disclosure contemplates edges between a user node 202 and a concept node 204 representing one or more relationships. As an example and not by way of limitation, an edge 206 may represent both that a user likes and has used at a particular concept. Alternatively, another edge 206 may represent each type of relationship (or multiples of a single relationship) between a user node 202 and a concept node 204 (as illustrated in FIG. 2 between user node 202 for user “E” and concept node 204 for “SPOTIFY”).

In particular embodiments, the social-networking system 160 may create an edge 206 between a user node 202 and a concept node 204 in the social graph 200. As an example and not by way of limitation, a user viewing a concept-profile interface (such as, for example, by using a web browser or a special-purpose application hosted by the user's client system 130) may indicate that he or she likes the concept represented by the concept node 204 by clicking or selecting a “Like” icon, which may cause the user's client system 130 to send to the social-networking system 160 a message indicating the user's liking of the concept associated with the concept-profile interface. In response to the message, the social-networking system 160 may create an edge 206 between user node 202 associated with the user and concept node 204, as illustrated by “like” edge 206 between the user and concept node 204. In particular embodiments, the social-networking system 160 may store an edge 206 in one or more data stores. In particular embodiments, an edge 206 may be automatically formed by the social-networking system 160 in response to a particular user action. As an example and not by way of limitation, if a first user uploads a picture, watches a movie, or listens to a song, an edge 206 may be formed between user node 202 corresponding to the first user and concept nodes 204 corresponding to those concepts. Although this disclosure describes forming particular edges 206 in particular manners, this disclosure contemplates forming any suitable edges 206 in any suitable manner.

### Search Queries on Online Social Networks

In particular embodiments, the social-networking system 160 may receive, from a client system of a user of an online social network, a query inputted by the user. The user may submit the query to the social-networking system 160 by, for example, selecting a query input or inputting text into query field. A user of an online social network may search for information relating to a specific subject matter (e.g., users, concepts, external content or resource) by providing a short phrase describing the subject matter, often referred to as a “search query,” to a search engine. The query may be an unstructured text query and may comprise one or more text strings (which may include one or more n-grams). In general, a user may input any character string into a query field to search for content on the social-networking system 160 that matches the text query. The social-networking system 160 may then search a data store 164 (or, in particular, a social-graph database) to identify content matching the query. The search engine may conduct a search based on the query phrase using various search algorithms and generate search results that identify resources or content (e.g., user-profile interfaces, content-profile interfaces, or external resources) that are most likely to be related to the search query. To conduct a search, a user may input or send a search query to the search engine. In response, the search engine may identify one or more resources that are likely to be related to the search query, each of which may individually be referred to as a “search result,” or collectively be referred to as the “search results” corresponding to the search query. The identified content may include, for example, social-graph elements (i.e., user nodes 202, concept nodes 204, edges 206), profile interfaces, external web interfaces, or any combination thereof. The social-networking system 160 may then generate a search-results interface with search results corresponding to the identified content and send the search-results interface to the user. The search results may be presented to the user, often in the form of a list of links on the search-results interface, each link being associated with a different interface that contains some of the identified resources or content. In particular embodiments, each link in the search results may be in the form of a Uniform Resource Locator (URL) that specifies where the corresponding interface is located and the mechanism for retrieving it. The social-networking system 160 may then send the search-results interface to the web browser 132 on the user's client system 130. The user may then click on the URL links or otherwise select the content from the search-results interface to access the content from the social-networking system 160 or from an external system (such as, for example, a third-party system 170), as appropriate. The resources may be ranked and presented to the user according to their relative degrees of relevance to the search query. The search results may also be ranked and presented to the user according to their relative degree of relevance to the user. In other words, the search results may be personalized for the querying user based on, for example, social-graph information, user information, search or browsing history of the user, or other suitable information related to the user. In particular embodiments, ranking of the resources may be determined by a ranking algorithm implemented by the search engine. As an example and not by way of limitation, resources that are more relevant to the search query or to the user may be ranked higher than the resources that are less relevant to the search query or the user. In particular embodiments, the search engine may limit its search to resources and content on the online social network. However, in particular embodiments, the search engine may also search for resources or contents on other sources, such as a third-party system 170, the internet or World Wide Web, or other suitable sources. Although this disclosure describes querying the social-networking system 160 in a particular manner, this disclosure contemplates querying the social-networking system 160 in any suitable manner.

Typeahead Processes and Queries

In particular embodiments, one or more client-side and/or backend (server-side) processes may implement and utilize a “typeahead” feature that may automatically attempt to match social-graph elements (e.g., user nodes 202, concept nodes 204, or edges 206) to information currently being entered by a user in an input form rendered in conjunction with a requested interface (such as, for example, a user-profile interface, a concept-profile interface, a search-results interface, a user interface/view state of a native application associated with the online social network, or another suitable interface of the online social network), which may be hosted by or accessible in the social-networking system 160. In particular embodiments, as a user is entering text to make a declaration, the typeahead feature may attempt to match the string of textual characters being entered in the declaration to strings of characters (e.g., names, descriptions) corresponding to users, concepts, or edges and their corresponding elements in the social graph 200. In particular embodiments, when a match is found, the typeahead feature may automatically populate the form with a reference to the social-graph element (such as, for example, the node name/type, node ID, edge name/type, edge ID, or another suitable reference or identifier) of the existing social-graph element. In particular embodiments, as the user enters characters into a form box, the typeahead process may read the string of entered textual characters. As each keystroke is made, the frontend-typeahead process may send the entered character string as a request (or call) to the backend-typeahead process executing within the social-networking system 160. In particular embodiments, the typeahead process may use one or more matching algorithms to attempt to identify matching social-graph elements. In particular embodiments, when a match or matches are found, the typeahead process may send a response to the user's client system 130 that may include, for example, the names (name strings) or descriptions of the matching social-graph elements as well as, potentially, other metadata associated with the matching social-graph elements. As an example and not by way of limitation, if a user enters the characters “pok” into a query field, the typeahead process may display a drop-down menu that displays names of matching existing profile interfaces and respective user nodes 202 or concept nodes 204, such as a profile interface named or devoted to “poker” or “pokemon,” which the user can then click on or otherwise select thereby confirming the desire to declare the matched user or concept name corresponding to the selected node.

More information on typeahead processes may be found in U.S. patent application Ser. No. 12/763162, filed 19 Apr. 2010, and U.S. patent application Ser. No. 13/556072, filed 23 Jul. 2012, which are incorporated by reference.

In particular embodiments, the typeahead processes described herein may be applied to search queries entered by a user. As an example and not by way of limitation, as a user enters text characters into a query field, a typeahead process may attempt to identify one or more user nodes 202, concept nodes 204, or edges 206 that match the string of characters entered into the query field as the user is entering the characters. As the typeahead process receives requests or calls including a string or n-gram from the text query, the typeahead process may perform or cause to be performed a search to identify existing social-graph elements (i.e., user nodes 202, concept nodes 204, edges 206) having respective names, types, categories, or other identifiers matching the entered text. The typeahead process may use one or more matching algorithms to attempt to identify matching nodes or edges. When a match or matches are found, the typeahead process may send a response to the user's client system 130 that may include, for example, the names (name strings) of the matching nodes as well as, potentially, other metadata associated with the matching nodes. The typeahead process may then display a drop-down menu that displays names of matching existing profile interfaces and respective user nodes 202 or concept nodes 204, and displays names of matching edges 206 that may connect to the matching user nodes 202 or concept nodes 204, which the user can then click on or otherwise select thereby confirming the desire to search for the matched user or concept name corresponding to the selected node, or to search for users or concepts connected to the matched users or concepts by the matching edges. Alternatively, the typeahead process may simply auto-populate the form with the name or other identifier of the top-ranked match rather than display a drop-down menu. The user may then confirm the auto-populated declaration simply by keying “enter” on a keyboard or by clicking on the auto-populated declaration. Upon user confirmation of the matching nodes and edges, the typeahead process may send a request that informs the social-networking system 160 of the user's confirmation of a query containing the matching social-graph elements. In response to the request sent, the social-networking system 160 may automatically (or alternately based on an instruction in the request) call or otherwise search a social-graph database for the matching social-graph elements, or for social-graph elements connected to the matching social-graph elements as appropriate. Although this disclosure describes applying the typeahead processes to search queries in a particular manner, this disclosure contemplates applying the typeahead processes to search queries in any suitable manner.

In connection with search queries and search results, particular embodiments may utilize one or more systems, components, elements, functions, methods, operations, or steps disclosed in U.S. patent application Ser. No. 11/503093, filed 11 Aug. 2006, U.S. patent application Ser. No. 12/977027, filed 22 Dec. 2010, and U.S. patent application Ser. No. 12/978265, filed 23 Dec. 2010, which are incorporated by reference.

Structured Search Queries

In particular embodiments, in response to a text query received from a first user (i.e., the querying user), the social-networking system 160 may parse the text query and identify portions of the text query that correspond to particular social-graph elements. However, in some cases a query may include one or more terms that are ambiguous, where an ambiguous term is a term that may possibly correspond to multiple social-graph elements. To parse the ambiguous term, the social-networking system 160 may access a social graph 200 and then parse the text query to identify the social-graph elements that corresponded to ambiguous n-grams from the text query. The social-networking system 160 may then generate a set of structured queries, where each structured query corresponds to one of the possible matching social-graph elements. These structured queries may be based on strings generated by a grammar model, such that they are rendered in a natural-language syntax with references to the relevant social-graph elements. As an example and not by way of limitation, in response to the text query, “show me friends of my girlfriend,” the social-networking system 160 may generate a structured query “Friends of Stephanie,” where “Friends” and “Stephanie” in the structured query are references corresponding to particular social-graph elements. The reference to “Stephanie” would correspond to a particular user node 202 (where the social-networking system 160 has parsed the n-gram “my girlfriend” to correspond with a user node 202 for the user “Stephanie”), while the reference to “Friends” would correspond to friend-type edges 206 connecting that user node 202 to other user nodes 202 (i.e., edges 206 connecting to “Stephanie's” first-degree friends). When executing this structured query, the social-networking system 160 may identify one or more user nodes 202 connected by friend-type edges 206 to the user node 202 corresponding to “Stephanie”. As another example and not by way of limitation, in response to the text query, “friends who work at facebook,” the social-networking system 160 may generate a structured query “My friends who work at Facebook,” where “my friends,” “work at,” and “Facebook” in the structured query are references corresponding to particular social-graph elements as described previously (i.e., a friend-type edge 206, a work-at-type edge 206, and concept node 204 corresponding to the company “Facebook”). By providing suggested structured queries in response to a user's text query, the social-networking system 160 may provide a powerful way for users of the online social network to search for elements represented in the social graph 200 based on their social-graph attributes and their relation to various social-graph elements. Structured queries may allow a querying user to search for content that is connected to particular users or concepts in the social graph 200 by particular edge-types. The structured queries may be sent to the first user and displayed in a drop-down menu (via, for example, a client-side typeahead process), where the first user can then select an appropriate query to search for the desired content. Some of the advantages of using the structured queries described herein include finding users of the online social network based upon limited information, bringing together virtual indexes of content from the online social network based on the relation of that content to various social-graph elements, or finding content related to you and/or your friends. Although this disclosure describes generating particular structured queries in a particular manner, this disclosure contemplates generating any suitable structured queries in any suitable manner.

More information on element detection and parsing queries may be found in U.S. patent application Ser. No. 13/556072, filed 23 Jul. 2012, U.S. patent application Ser. No. 13/731866, filed 31 Dec. 2012, and U.S. patent application Ser. No. 13/732101, filed 31 Dec. 2012, each of which is incorporated by reference. More information on structured search queries and grammar models may be found in U.S. patent application Ser. No. 13/556072, filed 23 Jul. 2012, U.S. patent application Ser. No. 13/674695, filed 12 Nov. 2012, and U.S. patent application Ser. No. 13/731866, filed 31 Dec. 2012, each of which is incorporated by reference.

Generating Keywords and Keyword Queries

In particular embodiments, the social-networking system 160 may provide customized keyword completion suggestions to a querying user as the user is inputting a text string into a query field. Keyword completion suggestions may be provided to the user in a non-structured format. In order to generate a keyword completion suggestion, the social-networking system 160 may access multiple sources within the social-networking system 160 to generate keyword completion suggestions, score the keyword completion suggestions from the multiple sources, and then return the keyword completion suggestions to the user. As an example and not by way of limitation, if a user types the query “friends stan,” then the social-networking system 160 may suggest, for example, “friends stanford,” “friends stanford university,” “friends stanley,” “friends stanley cooper,” “friends stanley kubrick,” “friends stanley cup,” and “friends stanlonski.” In this example, the social-networking system 160 is suggesting the keywords which are modifications of the ambiguous n-gram “stan,” where the suggestions may be generated from a variety of keyword generators. The social-networking system 160 may have selected the keyword completion suggestions because the user is connected in some way to the suggestions. As an example and not by way of limitation, the querying user may be connected within the social graph 200 to the concept node 204 corresponding to Stanford University, for example by like- or attended-type edges 206. The querying user may also have a friend named Stanley Cooper. Although this disclosure describes generating keyword completion suggestions in a particular manner, this disclosure contemplates generating keyword completion suggestions in any suitable manner.

More information on keyword queries may be found in U.S. patent application Ser. No. 14/244748, filed 3 Apr. 2014, U.S. patent application Ser. No. 14/470607, filed 27 Aug. 2014, and U.S. patent application Ser. No. 14/561418, filed 5 Dec. 2014, each of which is incorporated by reference.

### Indexing Based on Object-type

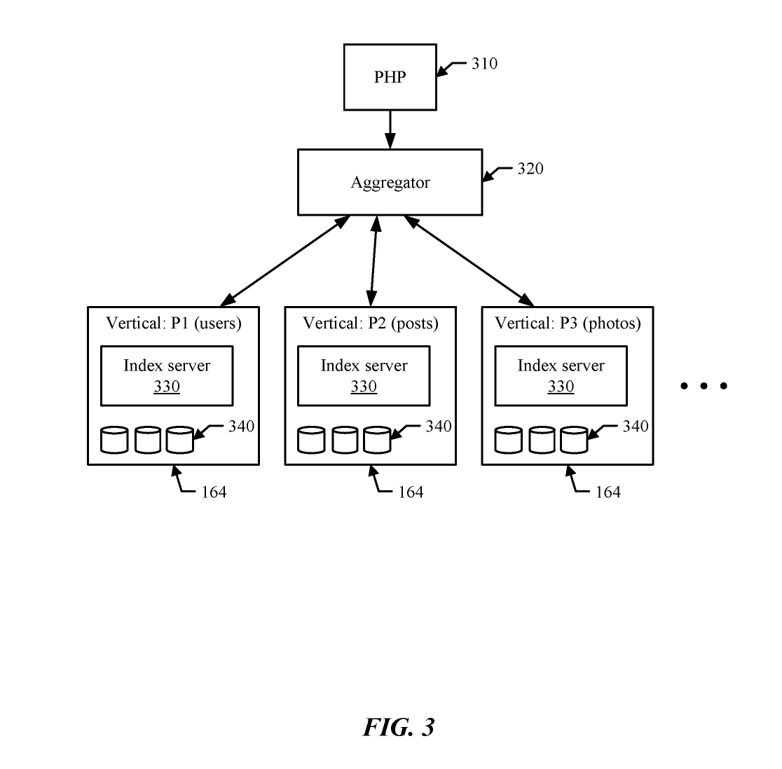

FIG. 3 illustrates an example partitioning for storing objects of a social-networking system 160. A plurality of data stores 164 (which may also be called “verticals”) may store objects of social-networking system 160. The amount of data (e.g., data for a social graph 200) stored in the data stores may be very large. As an example and not by way of limitation, a social graph used by Facebook, Inc. of Menlo Park, Calif. can have a number of nodes in the order of 10⁸, and a number of edges in the order of 10¹⁰. Typically, a large collection of data such as a large database may be divided into a number of partitions. As the index for each partition of a database is smaller than the index for the overall database, the partitioning may improve performance in accessing the database. As the partitions may be distributed over a large number of servers, the partitioning may also improve performance and reliability in accessing the database. Ordinarily, a database may be partitioned by storing rows (or columns) of the database separately. In particular embodiments, a database may be partitioned based on object-types. Data objects may be stored in a plurality of partitions, each partition holding data objects of a single object-type. In particular embodiments, social-networking system 160 may retrieve search results in response to a search query by submitting the search query to a particular partition storing objects of the same object-type as the search query's expected results. Although this disclosure describes storing objects in a particular manner, this disclosure contemplates storing objects in any suitable manner.

In particular embodiments, each object may correspond to a particular node of a social graph 200. An edge 206 connecting the particular node and another node may indicate a relationship between objects corresponding to these nodes. In addition to storing objects, a particular data store may also store social-graph information relating to the object. Alternatively, social-graph information about particular objects may be stored in a different data store from the objects. Social-networking system 160 may update the search index of the data store based on newly received objects, and relationships associated with the received objects.

In particular embodiments, each data store 164 may be configured to store objects of a particular one of a plurality of object-types in respective data storage devices 340. An object-type may be, for example, a user, a photo, a post, a comment, a message, an event listing, a web interface, an application, a location, a user-profile interface, a concept-profile interface, a user group, an audio file, a video, an offer/coupon, or another suitable type of object. Although this disclosure describes particular types of objects, this disclosure contemplates any suitable types of objects. As an example and not by way of limitation, a user vertical P1 illustrated in FIG. 3 may store user objects. Each user object stored in the user vertical P1 may comprise an identifier (e.g., a character string), a user name, and a profile picture for a user of the online social network. Social-networking system 160 may also store in the user vertical P1 information associated with a user object such as language, location, education, contact information, interests, relationship status, a list of friends/contacts, a list of family members, privacy settings, and so on. As an example and not by way of limitation, a post vertical P2 illustrated in FIG. 3 may store post objects. Each post object stored in the post vertical P2 may comprise an identifier, a text string for a post posted to social-networking system 160. Social-networking system 160 may also store in the post vertical P2 information associated with a post object such as a time stamp, an author, privacy settings, users who like the post, a count of likes, comments, a count of comments, location, and so on. As an example and not by way of limitation, a photo vertical P3 may store photo objects (or objects of other media types such as video or audio). Each photo object stored in the photo vertical P3 may comprise an identifier and a photo. Social-networking system 160 may also store in the photo vertical P3 information associated with a photo object such as a time stamp, an author, privacy settings, users who are tagged in the photo, users who like the photo, comments, and so on. In particular embodiments, each data store may also be configured to store information associated with each stored object in data storage devices 340.

In particular embodiments, objects stored in each vertical 164 may be indexed by one or more search indices. The search indices may be hosted by respective index server 330 comprising one or more computing devices (e.g., servers). The index server 330 may update the search indices based on data (e.g., a photo and information associated with a photo) submitted to social-networking system 160 by users or other processes of social-networking system 160 (or a third-party system). The index server 330 may also update the search indices periodically (e.g., every 24 hours). The index server 330 may receive a query comprising a search term, and access and retrieve search results from one or more search indices corresponding to the search term. In some embodiments, a vertical corresponding to a particular object-type may comprise a plurality of physical or logical partitions, each comprising respective search indices.

In particular embodiments, social-networking system 160 may receive a search query from a PHP (Hypertext Preprocessor) process 310. The PHP process 310 may comprise one or more computing processes hosted by one or more servers 162 of social-networking system 160. The search query may be a text string or a search query submitted to the PHP process by a user or another process of social-networking system 160 (or third-party system 170). In particular embodiments, an aggregator 320 may be configured to receive the search query from PHP process 310 and distribute the search query to each vertical. The aggregator may comprise one or more computing processes (or programs) hosted by one or more computing devices (e.g. servers) of the social-networking system 160. Particular embodiments may maintain the plurality of verticals 164 as illustrated in FIG. 3. Each of the verticals 164 may be configured to store a single type of object indexed by a search index as described earlier. In particular embodiments, the aggregator 320 may receive a search request. For example, the aggregator 320 may receive a search request from a PHP (Hypertext Preprocessor) process 210 illustrated in FIG. 2. In particular embodiments, the search request may comprise a text string. The search request may be a structured or substantially unstructured text string submitted by a user via a PHP process. The search request may also be structured or a substantially unstructured text string received from another process of the social-networking system 160. In particular embodiments, the aggregator 320 may determine one or more search queries based on the received search request. In particular embodiments, each of the search queries may have a single object type for its expected results (i.e., a single result-type). In particular embodiments, the aggregator 320 may, for each of the search queries, access and retrieve search query results from at least one of the verticals 164, wherein the at least one vertical 164 is configured to store objects of the object type of the search query (i.e., the result-type of the search query). In particular embodiments, the aggregator 320 may aggregate search query results of the respective search queries. For example, the aggregator 320 may submit a search query to a particular vertical and access index server 330 of the vertical, causing index server 330 to return results for the search query.

More information on indexes and search queries may be found in U.S. patent application Ser. No. 13/560212, filed 27 Jul. 2012, U.S. patent application Ser. No. 13/560901, filed 27 Jul. 2012, U.S. patent application Ser. No. 13/723861, filed 21 Dec. 2012, and U.S. patent application Ser. No. 13/870113, filed 25 Apr. 2013, each of which is incorporated by reference.

### Snippet Generation for Content Search

In particular embodiments, the social-networking system 160 may identify and rank content objects matching a search query based on snippets, and snippet-related ranking factors, extracted from the content objects. A snippet is a segment of a content object determined to be representative of a content object and extracted from the content object. As an example, a snippet may be a text segment extracted from a post-type object. A snippet may be shown to a user as the user is viewing search results to give the user an idea of the content of the content object corresponding to each search result. A snippet may be selected in a uniform manner for each content object or type of content object, agnostic of the actual content therein. For example, selecting snippet may include displaying the first sentence, the first paragraph, a headline, or designated lead paragraph. Often, however, the sections of a post that are most relevant to a user or to a search query may not be contained in the opening lines or paragraphs of a post. Selecting a snippet to display in a uniform manner could confuse the user, cause a user to fail to select a particularly relevant result, the relevance of which is obscured by a poorly chosen snippet, or cause a user to select a search result that seemed more relevant based on the snippet displayed, but was not relevant when the full text of the post was considered. Therefore techniques for selecting relevant snippets to display to a user can provide the user with more valuable search results. Techniques are described herein for improving the quality of the snippet selected for a content object. With the improved quality of snippets, the characteristics and interaction history of each snippet may be used to provide improved techniques for ranking search results that may be used in place of or in addition to ranking features related to the content object itself. Search results generated based on the improved snippets and snippet-related ranking features may more clearly demonstrate to a user why a particular post is relevant to their search query. This may improve user engagement and satisfaction with search queries in general. This may also improve the performance of the social-networking system. Previously, a user accessing a search results page had to select a search result, causing the social-networking system to serve the underlying content object, before the user could determine the relevance of the search result. If the user was not satisfied with the content object, the user must return to the search results page, served by the social-networking system, and select an additional search result. Improved snippets may allow a user to more effectively determine the quality or relevance of a search result before the full content object is loaded, reducing the number of content objects served by the social-networking system and the number of additional search result page loads. Although these techniques are described in the context of post-type objects, it may be more broadly applicable to any content object, especially one including a text description. As an example and not by way of limitation, the social-networking system 160 may receive a search query “Indivisible NPR.” The social-networking system 160 may identify content objects matching the n-grams of the search query. The content objects may be post-type objects discussing the podcast “Indivisible” produced by NPR, or news stories about said podcast. The social-networking system 160 may generate a snippet for each of the identified content objects. The social-networking system 160 may rank the content objects based on factors related to each content object, such as the author of the content object, and factors related to the to the snippet generated for each content object, such as how often the n-grams of the search query are used. The social-networking system 160 may generate search results comprising the content objects and related snippets and present the search results to the searching user. More information on snippets may be found in U.S. patent application Ser. No. 13/827214, filed 14 Mar. 2014, U.S. patent application Ser. No. 14/797819, filed 13 Jul. 2015, U.S. patent application Ser. No. 14/938685, filed 11 Nov. 2015, U.S. patent application Ser. No. 14/996937, filed 15 Jan. 2016, and U.S. patent application Ser. No. 15/459678, filed 15 Mar. 2017, which are incorporated by reference. Although this disclosure describes generating search results in a particular manner, this disclosure contemplates generating search results in any suitable manner.

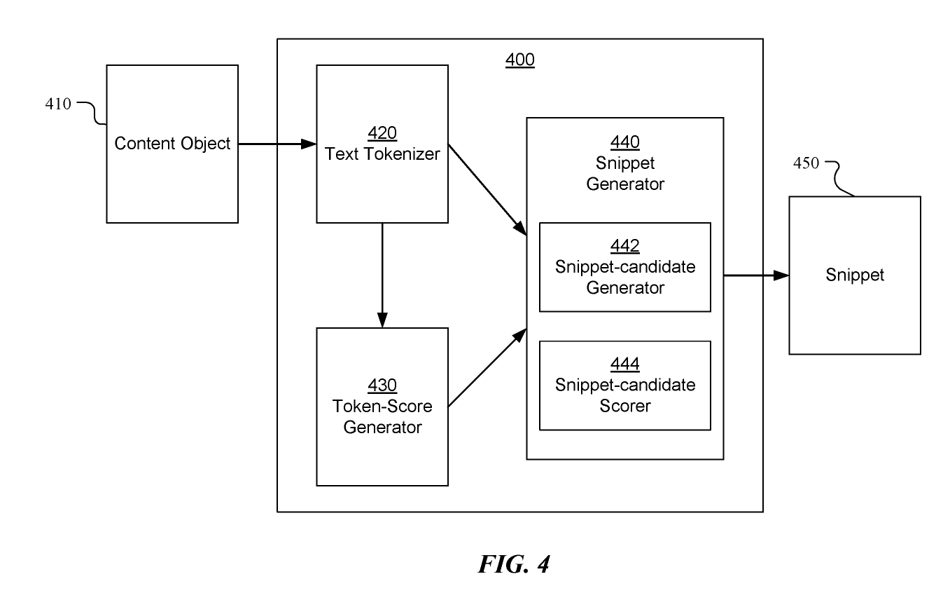

FIG. 4 illustrates an example snippet-generation module 400 of the social-networking system 160. The snippet-generation module 400 may comprise a plurality of components, each of which may be itself comprised of a plurality of sub-components. The snippet-generation module may comprise a text tokenizer 420, a token-score generator 430, and a snippet generator 440. The snippet generator 440 may comprise a snippet-candidate generator 442 and a snippet-candidate scorer 444. FIG. 4 also illustrates a flow of information as the snippet-generation module 400 receives a content object 410 and extracts a suitable snippet 450 according to the techniques described here in. Although FIG. 4 illustrates a snippet-generation module 400 comprising specific components, a snippet-generation module 400 may comprise any combination of suitable components. Furthermore, although this disclosure describes and illustrates the behavior of a snippet-generation module 400 in a particular manner, this disclosure contemplates any suitable behavior of a snippet-generation module 400 and any components, or sub-components, thereof.

In particular embodiments, the social-networking system 160 may receive, from a client system 130, a search query comprising one or more n-grams. One function of an online social network may be to allow users to search for content related to topics of interest. The social-networking system 160 may provide a variety of user interfaces allowing a user to perform such searches. The interface may comprise a dedicated search field, or other input into which a user may enter a query. The query may be entered by the user selecting the search field and entering characters of text using functions available on the user's client system 130. The user may also enter the query through other inputs, such as a voice input. Once the user has input the search query, the client system 130 may send the search query. The social-networking system 160 may receive, at one or more query-receiving servers 162 (such as PHP process 310), the search query. The social-networking system 160 may normalize and parse the search query into one or more n-grams. The social-networking system 160 may normalize the search query by using techniques to bring the search query into a standardized format to improve searching efficiency. This may include removing extraneous (e.g., leading, trailing, or buffer) white space, removing common or stop words, converting all text into lowercase lettering, transforming the n-grams into a standardized spelling to remove regional differences, any other suitable normalization techniques, or any combination thereof In particular embodiments, the normalizing and parsing may be performed by the client system 130 before sending the search query to the social-networking system 160. As an example and not by way of limitation, the social-networking system 160 may receive the search query “Jamie xx In Colour”. The social-networking system 160 may normalize and parse the search query it to generate the n-grams “jamie,” “xx,” “color,” “jamie xx,” and “in colour.” In this example, the social-networking system 160 generated the n-gram “color” by removing the stop word “in” and normalizing the spelling to the American spelling, and also generated the n-gram “in colour” by recognizing the name of a content object—the album “In Colour” by the artist Jamie xx. Although this disclosure describes receiving a search query in a particular manner, this disclosure contemplates receiving a search query in any suitable manner.

In particular embodiments, the social-networking system 160 may identify, by a search-engine server 162, a plurality of content objects matching the search query, wherein each content object comprises a plurality of content tokens. The search query may be received by a search-engine server 162. The search-engine server 162 may identify a plurality of content objects by searching one or more indices of one or more data stores 164, respectively, using the n-grams of the search query using the techniques described above. The social-networking system 160 may identify a plurality of content objects using any suitable techniques. The search-engine server may send the plurality of content objects to the snippet-generation module 400 of the social-networking system 160. In particular embodiments, a text tokenizer 420 may receive each content object 410 of the plurality of content objects and parse the content object 410 to produce one or more content tokens from the content object 410. In particular embodiments, each content token may be an n-gram. Each content token may correspond to a word, a user name, or a concept name. While parsing the content object 410, the text tokenizer 420 may preserve the specific ordering of the content tokens as the original n-grams of the content object 410 appeared. The order of the content tokens may be maintained because snippets are presented to the user as a text segment directly extracted from the content object. Thus the ordering of the content tokens is critical. The content tokens may be n-grams of any suitable size (e.g., unigrams, bigrams, etc.), including phrases, based on the context of the post token. For example, the text tokenizer 420 may receive a content object and may parse the content object to produce a plurality of content tokens. As an example, the text tokenizer 420 may recognize the name of a user of the online social network, such that the bigram “Mark Hamill” is recognized as the name of a friend of the searching user. As another example, the text tokenizer 420 may recognize the name of an event such that phrase “Star Wars Episode VII Release Party” is recognized as a concept name, referring to an event and preserve the concept name as a content token rather than parse it into separate tokens.

In particular embodiments, the content objects may be posts comprising text. Each snippet may comprise a text segment extracted from the text of the respective post. The content objects retrieved by the search-engine server 162 may be posts created by one or more users of the online social network. The snippets from each content object may be text extracted from the post. As an example and not by way of limitation, the search-engine server may search a data store 164 that stores posts created by users of the online social network. These posts may be sent to and received by the snippet-generation module 400 of the social-networking system 160. The snippet-generation module 400 may determine, for each post received, a snippet determined to be representative of the post. In particular embodiments, the content objects may be web pages. Each snippet may comprise a text segment extracted from the text of the respective web page. The search-engine server 162 may perform a search of one or more web pages of one or more websites external to the online social network. These external websites may make their web pages and other content available to the search-engine server 162 through an Application Programming Interface (API) or the search-engine server 162 may crawl the content of the website to index the content for efficient searching. The snippet-generation module 400 may receive these external web pages and determine, for each web page, a snippet from the content of the web page, determined to be representative of the web page. Similar search, crawl, and retrieval techniques may also be applied to content extracted from mobile applications, or any other source of content, such as by following deep links to the respective content. In particular embodiments, the content objects may be streaming or online media content, such as audio or video files. Each snippet may comprise a text segment extracted from a transcription or video description of the media content. The search-engine server 162 may access one or more data stores 164 storing media content objects and send the media to the snippet-generation module 400. The snippet-generation module may access a transcription of the media and generate a text segment from the transcription. The transcription of the media file may be stored in association with the media file, or may be accessed from an associated data store 164. The snippet-generation module 400 may further comprise a transcription component that performs the transcription on the fly. The transcription may also be a text translation of the media. As an example and not by way of limitation, the search-engine server 162 of the social-networking system 160 may access a data store 164 holding videos describing recent news events. Each video may be stored with native-language transcription of the video as well as one or more translations of the video. The snippet-generation module 400 may detect a preferred language of a searching user and prepare a snippet from the corresponding translation. Although this disclosure describes particular content object types, this disclosure contemplates any suitable content objects.

In particular embodiments, the social-networking system 160 may determine, by a token-score generator, a token score for each content token of the plurality of content tokens from each content object, wherein the token score is based on one or more positive factors or one or more negative factors. The token score for a given content token 410 may be a calculated measure of the importance or relative value of the content token in a snippet as compared to the other content tokens of the content object 410. A token-score generator 430 may receive the content tokens and determine a token score for each content token. The token-score generator 430 may receive the content tokens from the text tokenizer 420. The token score for a content token 410 may be calculated based on one or more factors. Each factor in turn may be based on a number of independent scoring signals. Each of the factors may be associated with a weight according to the determined predictive value of the factor, the type of the factor, or what the factor indicates. The predictive value of the factor may be determined according to one or more machine learning models. The token-score generator 430 may calculate a score for each content token based on a combination of the weighted scores for each factor. As an example and not by way of limitation, the token-score generator 430 may calculate the score for each content token as a weighted sum of the token's factors. A score for a post token, token, may be determined according to an algorithm comprising the formula:

$$token\_score ( {token}_{i} ) = {\sum }_{j} weight ( {factor}_{j} ) score ( {factor}_{j} , {token}_{i} )$$

where factorⱼ identifies a particular factor, weight(factorⱼ) gives the predictive weight of a factorⱼ, and score (factorⱼ, tokenᵢ) produces the value of the score of a factorⱼ for the given tokenᵢ. Although this disclosure describes scoring content tokens in a particular manner, this disclosure contemplates scoring content tokens in any suitable manner.

In particular embodiments, the scoring factors may include one or more factors that will increase the token score for a content token (i.e., one or more “positive factors.”). The one or more positive factors for a token score for a particular content token may increase the overall value of a snippet comprising that content token. In particular embodiments, the one or more positive factors of the token score for each content token may comprise a measure of similarity between the content token and one or more n-grams of the search query. The one or more positive factors of the token score may include whether the content token matches one or more n-grams of the search query. This may be based on a degree of similarity between the content token and the particular n-grams. As an example and not by way of limitation, the degree of similarity may be determined using a variety of suitable techniques, such as edit distance, semantic distance, stemming, phonetic matching, any other suitable technique for determining similarity between two n-grams, or any combination thereof. In particular embodiments, the one or more positive factors of the token score for each content token may comprise a measure of similarity between the content token and one or more trending topics. The positive factors may include whether the post token corresponds to, or is similar to, a trending topic. This may include a degree of similarity to the topic, determined using any of the suitable techniques described above. The factor may further include a degree of popularity of the trending topic. This degree of popularity may be based on a geographic region associated with a searching user, a current location of the client system 130, social-networking information (e.g., friends, profile information, interests) associated with the searching user, any other suitable basis for determining degree of popularity, or any combination thereof. In particular embodiments, the one or more positive factors of the token score for each content token may comprise a measure of a likelihood that the content token is an opinion-related content token. The positive factors may include whether the content token indicates an opinion of an author of the content object. Content tokens indicating either a positive or negative opinion may be useful because they may inform a user reading a snippet comprising the content token of the overall opinion or character of the content object. That a content token indicates the opinion of the author of the content object may be determined using a measure of likelihood. The measure of likelihood may be, or may be based on, for example, a probability or a confidence score generated by the social-networking system 160. The measure of likelihood may be based on sentiment analysis, or other techniques useful for determining the intent of the author. The measure of likelihood may also reflect the relative strength of the opinion being demonstrated through the use of the particular content token. As an example, the text tokenizer 420 may have identified the content tokens “just” and “love” from the phrase “I just love watching the Warriors win” in a content object 410. An opinion-related positive factor may be relatively high for the content token “love,” as the token-score generator 430 may have determined with a high confidence score that the content token “love” is related to the opinion of the author of the content object. An opinion-related positive factor for the content token “just” may be relatively low because the token-score generator 430 may have a low confidence that the content token “just” alone indicates the opinion of the author of the content object. Although this disclosure describes scoring content tokens in a particular manner, this disclosure contemplates scoring content tokens in any suitable manner.

In particular embodiments, the scoring factors may include factors that decrease the overall score of a snippet containing that word (i.e., “negative factors”). The one or more negative factors for a token score for a particular content token may decrease the overall value of a snippet comprising that content token. In particular embodiments, the one or more negative factors of the token score for each content token comprise a measure of offensiveness of the content token. Offensive language in a snippet may cause a user to avoid interacting with the content object associated with the snippet. The snippet-generation module 400 may avoid generating snippets that contain offensive language by decreasing the token score for a content token considered to be offensive. The measure of offensiveness may be determined by the social-networking system 160, the token-score generator 430, or any other suitable system or system component using a variety of techniques. The measure of offensiveness may be determined on a binary basis, such as by reference to a list of banned, or known offensive, words. A content token matching a word on the list may receive a full score for offensiveness, while a content token not matching a word on the list receives no score. Offensiveness is not necessarily a binary concept, and so the measure of offensiveness may be a continuous value. The measure of offensiveness may be based on a calculated measure of probability or confidence that the content token matches a word on the banned list. Offensiveness may also be determined relatively by reference to profile settings associated with a user. For example, a given content token may have a higher measure of offensiveness for a user younger than a determined age (e.g., younger than 18) than for a person above the determined age. The measure of offensiveness may be based on the preferences of a user. For example, a user may have customized a mature content filter to block terms they consider offensive that another user may not. The preferences may be stated explicitly (e.g., a user-specified list of terms) or implicitly (e.g., a list of terms determined by the social-networking system 160 to which a user has negatively reacted in the past). In particular embodiments, the one or more negative factors of the token score for each content token comprise a measure of a likelihood of the content token being misspelled. Snippets containing grammatical mistakes may be more difficult to read, and thus may cause users to avoid interacting with respective content objects. The snippet-generation module 400 may therefore avoid generating snippets with spelling, grammar, or other mistakes by reducing the token score for content tokens having these apparent errors. The token-score generator 430 may determine a measure of a likelihood (e.g., probability, confidence score, etc.) of a content token being misspelled by reference to language-dependent correctly spelled words, user names or concept names, trending or emerging terms, or any other suitable source of correctly spelled terms. The measure of a likelihood of the content token being misspelled may be determined on a binary basis (i.e., spelled correctly or not), or may rely on probability, confidence scores, or other suitable continuous values. The likelihood that a content token is misspelled may be determined by reference to a dictionary or list of terms, or may be determined by other advanced techniques. One technique, bloom filters, allow for efficient comparison of a word to a list of words. Bloom filters may also be used to determine whether a content token is a correctly spelled user name. More about bloom filters may be found in U.S. patent application Ser. No. 14/556368, filed 1 Dec. 2014, which is incorporated by reference. Another technique uses hidden markov models to determine whether a word is misspelled in a probabilistic fashion. More about hidden markov models used for spelling error detection may be found in U.S. patent application Ser. No. 14/684137, filed 10 Apr. 2015, which is incorporated by reference. Although this disclosure describes scoring content tokens in a particular manner, this disclosure contemplates scoring content tokens in any suitable manner.

In particular embodiments, the social-networking system 160 may determine, by the snippet generator 440, for each content object matching the search query, a snippet comprising a plurality of content tokens from the content object, the snippet being determined based on a token score associated with each content token from the content object. The content tokens generated by the text tokenizer 420 and the token scores generated by the token-score generator 430 may be received by the snippet generator 440. The snippet generator 440 may determine the snippet 450 for a given content object 410 by selecting a snippet with a highest value. The value of a snippet 450 may be based on the respective values of the token scores generated for the content tokens that make up the snippet 450. Although this disclosure describes generating snippets in a particular manner, this disclosure contemplates generating snippets in any suitable manner. In particular embodiments, the snippet generator 440 may determine the snippet for a content object based on the token score associated with each content token from the content object by determining a total token score of the snippet based on an algorithm comprising:

$${argmax}_{u , v} W = {\sum }_{k = 1}^{K} {\sum }_{i = {u}_{k}}^{{v}_{k}} S ( i ) ,$$

wherein W is the total token score of the snippet; N is a number of content tokens of the content object; M is a number of content tokens for the snippet; u and v are a start position and end position, respectively, of content tokens for each content object T(u,v)=1, . . . u, . . . v, . . . N; S(i) is a token score for the content token i; and K is a number of partitions permitted in each snippet candidate. This algorithm expresses a formal statement of an optimization problem: find the selection of content tokens that maximize the score W of the snippet subject to specific constraints, discussed in detail below. This optimization problem may be conceptualized as one or more sliding windows running over the content of the content object. The goal is to determine a number, size, and start and end positions of the window(s) such that the content tokens captured by the window provide the maximum score when compared to the other combinations. One approach to solving this problem may be to generate each possible variation of these windows and compare the scores. However, this solution may not be acceptable at large scales because the computational cost of generating and comparing these scores is enormous. For a single content object comprising 10 content tokens, there are over three million possible valid combinations of sliding windows. The complexity of the problem grows on a factorial scale with the number of content tokens in a given content object. Even limiting the windows to a minimum or maximum size, and limiting the minimum or maximum number of windows still does not resolve the complexity because it is compounded by the number of content objects considered and the number of queries received. In an environment with billions of users making billions of queries, and all requiring millisecond-speed responses, advanced techniques for generating snippets are necessary. The snippet generator 440 may be configured using dynamic programming techniques to efficiently solve this optimization problem. Although this disclosure describes generating snippets in a particular manner, this disclosure contemplates generating snippets in any suitable manner.

The problem can be decomposed into two cases based on the number of partitions permitted in each snippet (i.e., the number of sliding windows). In particular embodiments, the number of partitions permitted in each snippet candidate, K, may be 1, and the algorithm may comprise:

u=argmaxᵢW(i+M−1)−W(i), 1≤i≤N−M+1; and

v=u+M−1

wherein W(i), the total token score of a snippet, may be defined as

$$W ( i ) = \{ \begin{matrix}{\sum }_{j = 1}^{i} S ( j ) , 1 \leq i \leq N \\ 0 , i = 0\end{matrix} .$$

In this case, only a single partition is necessary. Therefore, the solution to the optimization problem is to find the single partition with the highest total token score W. In the formulas above, M is the fixed length of the snippet and Nis the fixed length of the content object. Expressed as the solution to determining the start and end positions of the snippet, u and v, respectively, the formula u=argmaxᵢW(i+M−1)−W(i) for 1≤i≤N−M+1 expresses that the solution is to find the start position of the snippet that yields the highest total accumulated weight. Because the length of the snippet is fixed, the value of the end position, v, is dependent on the value determined for u, namely v=u+M−1. Although this disclosure describes generating snippets in a particular manner, this disclosure contemplates generating snippets in any suitable manner.

In the other case, where more than one partition is allowed, the solution is more complex. This case of solutions is directed to snippets with non-consecutive partitions, but may also determine a solution where the snippets are consecutive. In particular embodiments, the number of partitions permitted in each snippet, K, may be greater than 1, and the algorithm may comprise:

$${v}_{k} = \{ \begin{matrix}{argmax}_{i} B ( k , i ) , & V ( k ) \leq i \leq N , k = K \\ {argmax}_{i} B ( k , i ) , & V ( k ) \leq i \leq {u}_{k + 1} , 1 \leq k \leq K\end{matrix} \\ {u}_{k} = {v}_{k} + L ( k ) + 1 , 1 \leq k \leq K ,$$

wherein B(k, i) is a maximum token score sum of i partitions and V(k) is a total length of the snippet. B(k, i) may be defined by the formula

$$B ( k , i ) = \{ \begin{matrix}\begin{matrix}argmax \{ B ( k - 1 , j ) + W ( i ) - W ( i - L ( k ) ) \} , 1 \leq k \leq K , \\ V ( k ) \leq i \leq N , V ( k - 1 ) \leq j \leq i - L ( k )\end{matrix} \\ 0 , k = 0 \\ 0 , i = 0 \\ 0 , i < V ( k )\end{matrix}$$

and V(k) may be defined by the formula

$$V ( k ) = \{ \begin{matrix}{\sum }_{j = 1}^{k} L ( j ) , 1 \leq k \leq K \\ 0 , k = 0\end{matrix}$$

wherein L (j) is a length of a jth snippet partition. W(i), the total token score of a snippet may be defined as

$$W ( i ) = \{ \begin{matrix}{\sum }_{j = 1}^{i} S ( j ) , 1 \leq i \leq N \\ 0 , i = 0\end{matrix} .$$

Similar to the single partition case, this solution is expressed in terms of a solution for the values of the start and end positions for each of the K snippets, {uₖ, vₖ}ₖ₋₁^{k=K}. However, in this case, vₖ, the end of snippet k, is determined first. The solution for vₖ is expressed by use of the recursive formula B(k, i). On the first iteration, B(k, i) begins to divide the snippet into partitions. The function blocks off a section of the snippet, and recursively searches for the snippet partition within that section with the most value, as expressed by the portion B(k−1, j). The remainder of the content object, or portion thereof, is then searched for the snippet within that partition with the largest value. The formula also contains checks to ensure that only valid snippets are considered. These checks include maintaining the correct number of snippet partitions (i.e., 1≤k≤K). The ordering of the snippets is also maintained. At any level of recursion, the search is limitation to a window bounded by the end of the previous snippet partition, as expressed by the condition V(k)≤i≤N. Overlap is prevented by enforcement of the condition V(k−1)≤j≤i−L(k) which requires that the previous partition cannot have an end point after the start point of the current level of recursion. The recursion is terminated (i.e., B(k,i)=0) when the level of recursion exceeds the number of snippet partitions (i.e., (B(k,i)=0, k=0, as k is decremented with each recursion), or when the content token being evaluated, i, falls out of the valid evaluative range (i.e., i=0 or i<V(k)). Although this disclosure describes generating snippets in a particular manner, this disclosure contemplates generating snippets in any suitable manner.

Although the scoring techniques and equations described herein describe a scoring model aimed at identifying content tokens with the highest token score and snippet candidates with the highest snippet score, this disclosure contemplates a model with a reverse scoring scheme, such as a cost-type scoring model. In a cost-type scoring model, the goal is to reduce the “cost” associated with an object by keeping the score as low, or as close to zero, as possible. In such a scheme, the “positive” factors may lower a given score and the “negative” factors may increase a score. This model may aim to identify the content tokens with the lowest token score and the snippet candidates with the lowest snippet score. The equations described above may be modified to accommodate such a model.

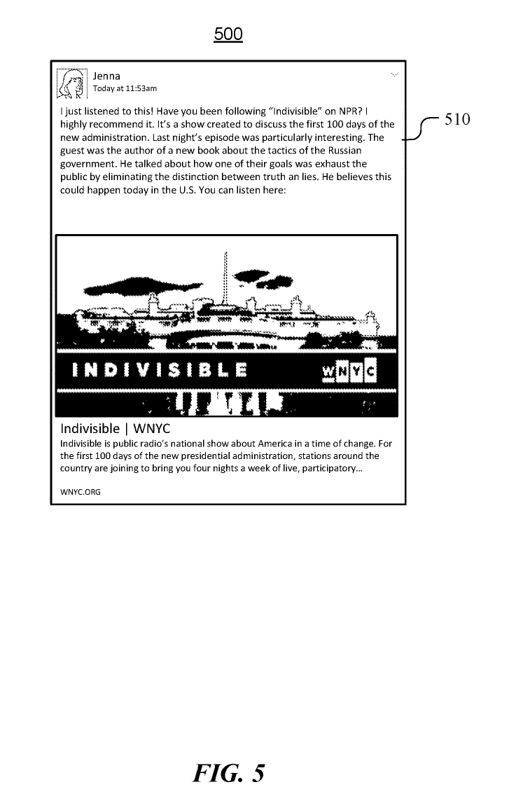

In particular embodiments, the snippet generator 440 may comprise a snippet-candidate generator 442. The social-networking system 160 may generate, by the snippet-candidate generator 442, a plurality of snippet candidates for each content object based on one or more snippet-candidate constraints. The snippet-candidate constraints may specify criteria for selecting content tokens for the snippet. Each snippet candidate may comprise a plurality of content tokens from the content object that satisfy the criteria specified in the one or more snipped-candidate constraints. The snippet-candidate generator 442 may produce a plurality of potential snippets for the content object (i.e., “snippet candidates”) for further analysis. The snippet-candidate generator 442 may perform the particular portion of the B(k, i) formula responsible for dividing the snippet into partitions. The snippet-candidate generator 442 may produce these snippet candidates by selecting contiguous content tokens from the content tokens of the content object. Contiguous content tokens may be used because the goal of the snippet is to provide to a user reading the snippet a means of accurately determining the value of the content object to the user. Presenting the content tokens as they appear in the content object may further this goal. The production of these snippet candidates may be based on a number of constraints. The constraints on the snippet candidates and snippet-candidate generator 442 may be designed to reduce the computational complexity, cost, and time required to generator the snippet 450. In particular embodiments, the snippet-candidate constraints may comprise a maximum number of content tokens of the snippet candidate. A maximum number of content tokens may be used to control the possible number of combinations that have to be considered. A minimum number of content tokens may also be used to ensure that enough information is conveyed to a user reading the snippet candidate. The constraints may be designed to ensure an optimal experience for the user who will be viewing the snippet 450. In particular embodiments, the snippet-candidate constraints may comprise a maximum length of the snippet candidate. The maximum length of the snippet candidate may refer to the number of characters in the snippet candidate. The length of a snippet may be an important consideration for a user when reviewing search results for content objects associated with snippets. If a snippet is too short, it may not be able to convey meaningful information. The user may also assume that the content object is short and devoid of useful information. On the other hand, if a snippet is too long, a user may be intimidated, or grow bored, and avoid reading the snippet or content object altogether. The maximum length of a snippet candidate may also be determined based on the client system 130 through which a user will be reviewing the search results. For example, a user viewing search results on client system 130 with a relatively small screen, such as a mobile client system 130 (e.g., an iPhone 7) might be shown shorter snippets so that more search results can be viewed at once. Conversely, a user viewing search results on a client system 130 with a relatively large screen (e.g., a laptop or desktop computer) may be shown longer snippets so that more information can be relayed at once. In particular embodiments, the snippet-candidate constraints may comprise a measure of contiguity of the content tokens of the snippet candidate. The measure of contiguity may be a value indicating the relatedness of the partitions that make up a snippet candidate. A snippet candidate may comprise multiple partitions. For relatively lengthy content objects, or content objects that are relevant to the search query for multiple reasons, a single, continuous snippet may not adequately capture the relevance of the content object. By incorporating multiple partitions of the content object, a single snippet can capture the various reasons why the content object is relevant. However, using multiple partitions may risk confusing the user by removing important context from the snippet or presenting the snippet in a misleading way. For example, if a snippet comprises two partitions of the content object, one from the beginning and one from the end, the reader may be confused because of the lost context of the body of the content object. A snippet constraint on the degree of contiguity may remove this problem by favoring the generation of snippet candidates composed of a low number of partitions that are near each other in the content object. The measure of contiguity may be based on the number of partitions, the relative positions of the partitions in the content object, the length of the snippet partitions, both in terms of character length and content token length, relative to each other, any other suitable basis, or any combination thereof. As an example and not by way of limitation, the social-networking system 160 may receive a search query and identify a plurality of content objects 410 matching the query. One content object of the plurality of content objects 410 may be the content object 500 shown in FIG. 5. A text tokenizer 420 may identify content tokens from the text 510 of the content object 500 and a token-score generator 430 may generate scores for those content tokens. A snippet-candidate generator 442 may receive the content tokens and generate a plurality of snippet candidates. One snippet candidate may be the contiguous text segment “Have you been following ‘Indivisible’ on NPR?' I highly recommend it.”, another snippet candidate may be the text segment “Have you been following ‘Indivisible’ on NPR? . . . Last night's episode was particularly interesting.” comprising text from two partitions of the content object. Although this disclosure describes generating snippets in a particular manner, this disclosure contemplates generating snippets in any suitable manner.

In particular embodiments, the snippet generator 440 may comprise a snippet-candidate scorer 444. The social-networking system 160 may determine, by the snippet-candidate scorer 444, a candidate score for each snippet candidate, the candidate score being determined based on the token score associated with each content token of the snippet candidate. The snippet-candidate scorer 444 may receive the token scores generated by the token-score generator 430 and the snippet candidates generated by the snippet-candidate generator 442 and produce a score for each snippet candidate (i.e., a “candidate score”). The snippet-candidate scorer 444 may calculate the candidate score of each snippet candidate based on a combination of the respective token scores of the content tokens comprising the snippet candidate. The snippet-candidate scorer 444 may perform the functions of the optimization problem described above related. As an example and not by way of limitation, the snippet-candidate scorer 444 may calculate a sum of the token scores of the content tokens of the snippet candidate. The candidate score may represent a probability that a snippet candidate will be relevant to the search query and to the user, or that the snippet candidate contains information that the user will find valuable or interesting. As an example and not by way of limitation, continuing from the example above, the snippet-candidate scorer 444 may receive the snippet candidates “Have you been following ‘Indivisible’ on NPR?' I highly recommend it.” and “Have you been following ‘Indivisible’ on NPR? . . . Last night's episode was particularly interesting.” generated by the snippet-candidate generator 442 and calculate a score for each based on the content tokens comprising each snippet candidate. In particular embodiments, the social-networking system 160 may select, by the snippet generator, from the plurality of snippet candidates for each content object, the snippet for the content object based on the determined snippet-candidate scores of the snippet candidates. The snippet-candidate scorer 444, snippet generator 440, or another suitable component may select the snippet 450 for a content object 410 from among the snippet candidates based on the candidate score. As an example, the snippet generator 440 may select the snippet candidate with the highest candidate score. As an example and not by way of limitation, continuing from the example above, the snippet generator 440 may select the snippet candidate “Have you been following ‘Indivisible’ on NPR?' I highly recommend it.” as the snippet for the content object 500 shown in FIG. 5. Particular embodiments of a snippet generator 440 may merge the roles of sub-components, such as the snippet-candidate generator 442 and snippet-candidate scorer 444 to improve the efficiency of this step. For example, dynamic programming techniques may be used to generate snippet candidates that are more likely to be high scoring. Although this disclosure describes generating snippets in a particular manner, this disclosure contemplates in any suitable manner.

In particular embodiments, the social-networking system 160 may rank each identified content object based on a content-object ranking-score calculated for the content object and a snippet ranking-score calculated for the snippet of the respective content object. Using the above-described techniques, each content object identified by the search-engine server 162 responsive to the user's search query may be associated with a snippet. The identified content objects may be ranked before presentation to the user. The content objects may be ranked based on a content-object ranking-score. The content-object ranking-score may represent a likelihood that the user will interact with a particular content object, that the particular content object is of interest to the user, that the particular content object is relevant to the search query, any other suitable basis for ranking content objects, or any combination thereof. The content-object ranking-score may be expressed as a probability, confidence score, or other suitable measure. The content objects may be ranked based on a snippet ranking-score calculated for the snippet associated with the content object. The snippet ranking-score for a particular snippet may correspond to a likelihood that the user will interact with the content object associated with the particular snippet based on the selection of the particular snippet for the content object. The content objects may be ranked based on a joint ranking score using features from both a content object and its associated snippet. Although this disclosure describes ranking content objects in a particular manner, this disclosure contemplates ranking content objects in any suitable manner.

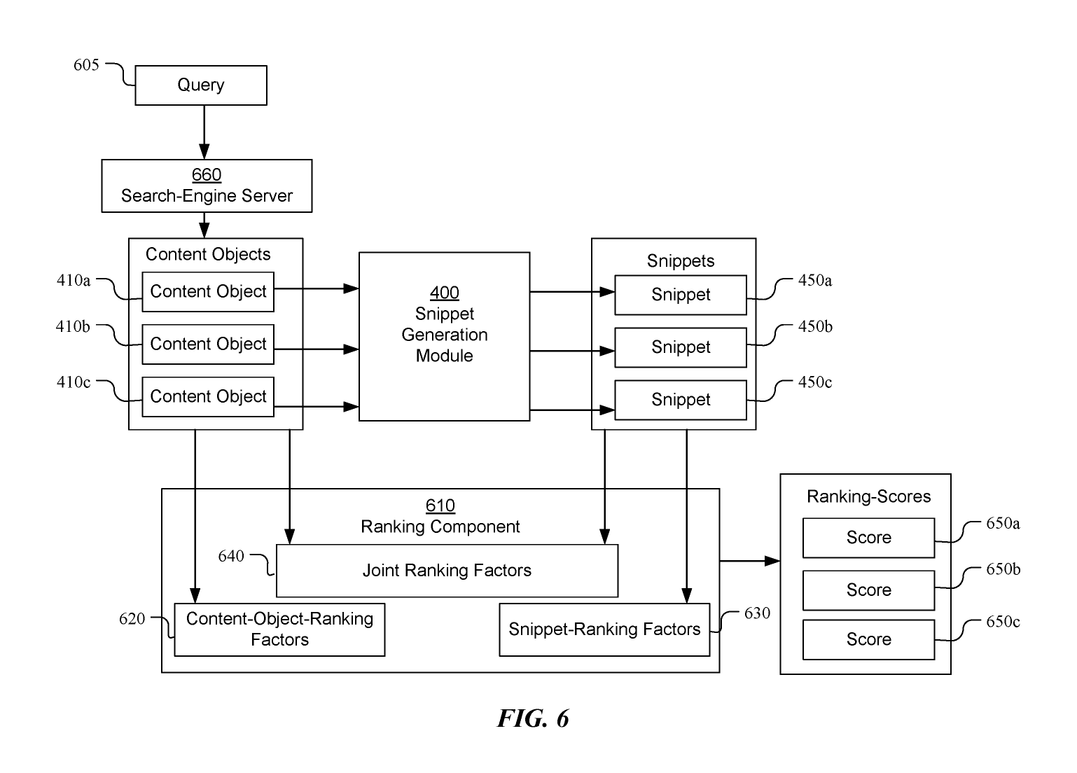

FIG. 6 illustrates a ranking component 610 of the social-networking system 160 and a flow of data between the search-engine server 660, snippet-generation module 400, and ranking component 610 of the social-networking system 160. The social-networking system 160 may receive a search query 605. A search-engine server 660 (which may be a server 162 from FIG. 1) of the social-networking system 160 may access one or more data stores 164 to retrieve a plurality of content objects 410. The search-engine server 660 has retrieved content objects 410a, 410b, and 410c. The search-engine server 660 may retrieve any suitable number of content objects 410. The content objects 410a, 410b, and 410c are sent to and received by the snippet-generation module 400 which uses one or more of the techniques described above to generator a snippet 450 for each content object 410. The snippet-generation module 400 has generated snippets 450a, 450b, and 450c for content objects 410a, 410b, and 410c, respectively. The content objects 410a, 410b, and 410c are sent to and received by the ranking component 610 along with the respective snippets 450a, 450b, and 450c. The ranking component 610 uses these content objects and snippets to rank the content objects 410a, 410b, and 410c and prepare search results 650. As indicated by the arrows representing the flow of data, the ranking component 610 uses content-object-ranking factors 620 based on the content objects 410a, 410b, and 410c themselves. The ranking component 610 uses snippet-ranking factors 630 based on the snippets 450a, 450b, and 450c corresponding to the content objects 410a, 410b, and 410c. The ranking component 610 also uses joint ranking factors 640 that take into account specific factors based on both the content objects 410a, 410b, and 410c and their respective snippets 450a, 450b, and 450c. The ranking component 610 uses these different factors to generate a ranking-score 650a, 650b, 650c for each content object 410a, 410b, and 410c and rank the content objects 410a, 410b, and 410c according to their respective score. Although FIG. 6 illustrates a ranking component 610 comprising specific components, a ranking component 610 may comprise any combination of suitable components. Furthermore, although this disclosure describes and illustrates the behavior of a ranking component 610 in a particular manner, this disclosure contemplates any suitable behavior of a ranking component 610 and any components, or sub-components, thereof.

In particular embodiments, the content-object ranking-score may be based on one or more content-object-ranking factors 620. The content-object-ranking factors may be any suitable basis for scoring and comparing a content object for the purposes of determining an ordering in which to display the content object to a user. The content-object-ranking factors 620 may comprise a measure of relevance of the content object to the search query. A content object may be relevant to a search query because the content object includes one or more of the n-grams of the search query. If the content object contains the n-grams of the search query, it is likely that the content object is responsive to the query and would be of interest to the user. A content object may also be relevant because the content object is directed to a similar topic as the search query. The topic of a search query and a content object may be determined by a user (i.e., through an explicit selection) or one or more components of the social-networking system 160. The social-networking system 160 may compare the n-grams of a search query to a database of topics that record common topics associated with those n-grams. The same may be true for the content objects. As an example, and not by way of limitation, the social-networking system 160 may receive the search query “steve yzerman.” The social-networking system 160 may retrieve a plurality of content objects. The social-networking system 160 may use a topic tagging data store 164 to determine that the search query “steve yzerman” is relevant to the topics “NHL,” “Detroit Red Wings,” “Tamba Bay Lightning,” and “Canadian hockey.” The social-networking system 160 may improve a score of a content-object ranking factor for content objects that have also been tagged with these topics. The content-object-ranking factors 620 may comprise a measure of relevance of an author of the content object to the search query. The social-networking system 160 may determine that one or more authors is an author that is relevant to a topic or particular n-grams referenced by the search query. An author may be relevant for many reasons, such as producing a large volume of content object relating to the search query, being personally involved or mentioned in the content object, being recognized as an expert on a topic referenced by the search query, and other suitable reason, or any combination thereof. As an example and not by way of limitation, the social-networking system 160 may receive the search query “steve yzerman.” The social-networking system 160 may determine that the user Mitch Albom, a sports columnist covering Detroit Red Wings Hockey, is a relevant author. More on determining a key or relevant author may be found in U.S. patent application Ser. No. 14/554190, filed 26 Nov. 2014 which is incorporated by reference. The content-object-ranking factors 620 may comprise a measure of relevance of the author of the content object to a user of the client system 130. The author of a content object may also be relevant to the user of the client system 130. An author may be relevant to the user because the user is connected to the author within a social graph 200, because the user has a high social affinity for the author (i.e., as measured by an affinity coefficient or degree of separation between the user and author in the social graph 200), because of mutual interests between the user and author, any other suitable reason, or any combination thereof. The content-object-ranking factors may comprise any other suitable basis for ranking a content object. Although this disclosure describes ranking objects in a particular manner, this disclosure contemplates ranking objects in any suitable manner.

In particular embodiments, the snippet ranking-score may be based on one or more snippet-ranking factors 630. The snippet-ranking factors 630 may comprise one or more textual properties of the snippet. The textual properties may be characteristics of the snippet ascertainable by examining the text of the snippet itself. As an example and not by way of limitation, the textual properties may include one or more of: the number of tokens in the snippet, the number of characters in the snippet, the start or end position of the snippet within the content object text, the number of opinion words within snippet, the strength of the opinion words in the snippet, the number of nouns, adjective, or other parts of speech in the snippet, any other suitable textual properties, or any combination thereof. The number of tokens or characters of the snippet may be relevant because the size of the snippet may impact the additive value of presenting the snippet with the content object. The position of the snippet within the content object text may be relevant because the position may be reflective of how accurately the snippet represents the content object itself. The number and strength of the opinion words may be relevant because they may allow the user to determine the context of the content object. The strength of opinion words may be determined using sentiment analysis or any other suitable technique. The snippet-ranking factors 630 may comprise one or more query-related characteristics of the snippet. The query-related characteristics may be properties that measure the relationship between the snippet and the search query. The query-related characteristics may include the number of content tokens within the snippet that match an n-gram of the search query, the degree of match between the matching content tokens and the n-grams of the search query, the distance between the first matching n-gram in the snippet and the last matching n-gram in the snippet, the smallest interval that contains all matching n-grams in the snippet, any other suitable characteristics, or any combination thereof. Because, ultimately, the snippet is intended to demonstrate to the user why a particular content object is relevant to their search query, the query-related characteristics of the snippet are a valuable measure of the value of the snippet. The number and degree of match of the matching content tokens will cause content object with snippets that are directly responsive to the search query to be up-ranked. Because words near each other in a sentence or paragraph are more likely to be related, the distances and size of intervals containing search query n-grams captures a measure of the relatedness of the matching content tokens. The snippet-ranking factors 630 may comprise a search history associated with the snippet. The social-networking system 160 may record the different snippets generated for a particular content object. The social-networking system 160 may capture and record the interactions users have with the snippet and with the content object as a result of the selection of the particular snippet. The social-networking system 160 may use this search history data, to compare the effects of the different snippets as they relate to different search queries or the preferences of users. The search history may include a stay time expectation, interaction probability, any other suitable search history information, or any combination thereof. A stay time expectation refers to the amount of time that users have, individually or collectively, spent reading the text of the snippet when it is display in association with its content object as a search result. A relatively high stay time may indicate that a snippet is useful to users in determining the relevance of a post to the search query, because users spend a significant amount of time viewing the snippet. The interaction probability also provides a quantitative measure of the relevant of a snippet. The interaction probability may be the likelihood that a user will interact (e.g., view, click, share, like, etc.) with a content object based on the content tokens of the snippet. The snippet-ranking factors may comprise any other suitable basis for ranking a snippet or any combination thereof Although this disclosure describes ranking objects in a particular manner, this disclosure contemplates ranking objects in any suitable manner.

In particular embodiments, the joint-ranking factors 640 may be factors that measure the relationship between the content object and the snippet as related to the search query. The joint-ranking factors 640 may comprise a joint search history of the content object and particular snippet. The joint search history may record the number of times the content object and particular snippet have been presented together and the success rate (as measured, e.g., by interactions) of search results comprising the content object and snippet. The joint-ranking factors 640 may comprise a joint popularity of the snippet and content object. The joint popularity may indicate a frequency of the content object and the text of the snippet (e.g., as a quote from the content object) being shared among users of the online social network. Although this disclosure describes ranking objects in a particular manner, this disclosure contemplates ranking objects in any suitable manner.

In particular embodiments, the content-object ranking-score, snippet ranking-score, and joint ranking-score may be combined to produce a final ranking score. As an example and not by way of limitation, the ranking component 610 may combine the ranking scores in a weighted sum. The weight of each ranking score may reflect the predictive value of the score towards determining a relevant or useful post. The ranking component 610 may also combine the ranking scores with weights in a manner that is more than merely additive (e.g., through a geometric, polynomial, or probabilistic equation). This disclosure contemplates any suitable method of combining the ranking scores, with or without weights. As an example, a final ranking-score may be determined according to an algorithm comprising the sum:

$$ranking\_score ( c , s ) = {\sum }_{i} weight ( {c\_factor}_{i} ) * score ( {c\_factor}_{i , c} ) + {\sum }_{j} weight ( {s\_factor}_{j} ) * score ( {s\_factor}_{j} , s ) + {\sum }_{k} weight ( {joint\_factor}_{k} ) * score ( {joint\_factor}_{k} , c , s )$$

where c is a content object, s is a snippet determined for that content object, c_factorᵢ is type of content-object ranking-score factor, sfactorⱼ is a type of snippet ranking-score factor, and joint_factorₖ is a type of joint ranking-score factor. The function weight(factor_type) may be implemented as a look-up table that references the type of the ranking-score factor and returns the weight to be applied to that particular factor type. The function score(factor_type, object) may retrieve the factor-score of the particular type calculated for a given content object or snippet. In particular embodiments, the weights used by the ranking component 610 to calculate the content-object ranking-score, snippet ranking-score, and joint ranking-score may be determined by one or more machine-learned models. The machine-learned models may automatically adjust the weights of different ranking-factors to optimize the presentation of search results with the goal of showing useful search results to the user. One method of determining useful search results may be to maximize user interactions with the search results. In some situations, the additive value of the snippet ranking-score may relatively low, for example when a relatively small number of content objects matching the search query have relatively high content-object ranking-scores. This indicates that only a relatively small number of content objects are likely to be responsive to the search query. In this event, the high content-object ranking scores may be more influential in determining rankings than snippet ranking-scores. This is because most, if not all, of the high-scoring content objects can be easily shown to the user. In other situations, the snippet ranking-score may be key in deciding among a large number of content objects with similar ranking scores. If the content-object ranking score is insufficient to differentiate between content objects, the snippet ranking-score may be used to tip the scales. The ranking component 610 may use the snippet-ranking score so that the content objects with high-impact snippets are shown to the user to ensure that the user can find information relevant to the search query. Although this disclosure describes ranking content objects in a particular manner, this disclosure contemplates ranking content objects in any suitable manner.

In particular embodiments, the social-networking system 160 may send, to the client system 130, instructions for presenting a search-results interface comprising a plurality of search results, each search result comprising a reference to a content object and a preview of the content of the respective content object, wherein the preview comprises the snippet associated with the content object, the search results being presented according to the rankings of the respective content objects. After generating the ranking scores, the social-networking system 160 may order the content objects and prepare a plurality of search results corresponding to a plurality of content objects, respectively. Each search result may comprise the content object or a reference to the content object and a preview of the content object. The preview of the content object may include information about or from the content object that allows the user to understand what the content object is and why it is responsive to the search query. The preview may include summary information, such as the snippet determined for the content object, as described above, the author of the content object, any other users associated with the content object, or a history of the content object. The preview may include social activity information corresponding to the content object, such as a number of users that have liked, shared, commented on, or viewed the content object. The social-networking system 160 may rank the search results based on their corresponding ranking-scores. The social-networking system 160 may send the search results to the client system 130 of the searching user. The social-networking system 160 may send instructions for presenting a search-results interface comprising the search results to the client system 130. The instructions may vary based on the type of client system 130 (e.g., mobile vs. desktop). The instructions may also vary based on how the user is accessing the social-networking system 160. For example, the search-results interface may differ if a user is accessing the social-networking system 160 through a dedicated application on the client system 130 provided by the online social network or if the user is accessing the social-networking system 160 through a web browser on the client system 130.

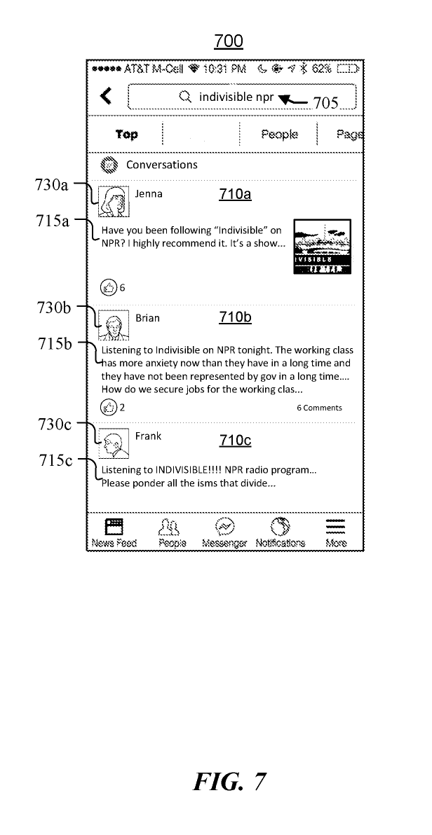

FIG. 7 illustrates an example search results page 700. As shown in FIG. 7, the social-networking system 160 has received a search query “indivisible npr” 705. The social-networking system 160 has identified a plurality of content objects 410 from a plurality of data stores 164 that match the search query 705. The content objects were received by a snippet-generation module 400. The snippet-generation module 400 generated a plurality of snippets 450 for the plurality of content objects 410 respectively. The content objects 410 and snippets 450 were received by a ranking component 610. The ranking component 610 has generated ranking-scores 650 for each content object. The social-networking system 160 has prepared instructions for presenting search results comprising the content objects in an order based on the ranking of the content objects. The search results page 700 for the search query 705 comprises search results 710a, 710b, and 710c. Each search result comprises a snippet 715a, 715b, and 715c and the author 730a, 730b, 730c of the content object. A user may access the content object associated with the search by interacting with the respective snippet. In particular embodiments, the user may access the content object associated with a search result by interacting with a link or dedicated reference to the content object. Search result 710a corresponds to content object 500 in FIG. 5. Although this disclosure describes presenting search results in a particular manner, this disclosure contemplates presenting search results in any suitable manner.

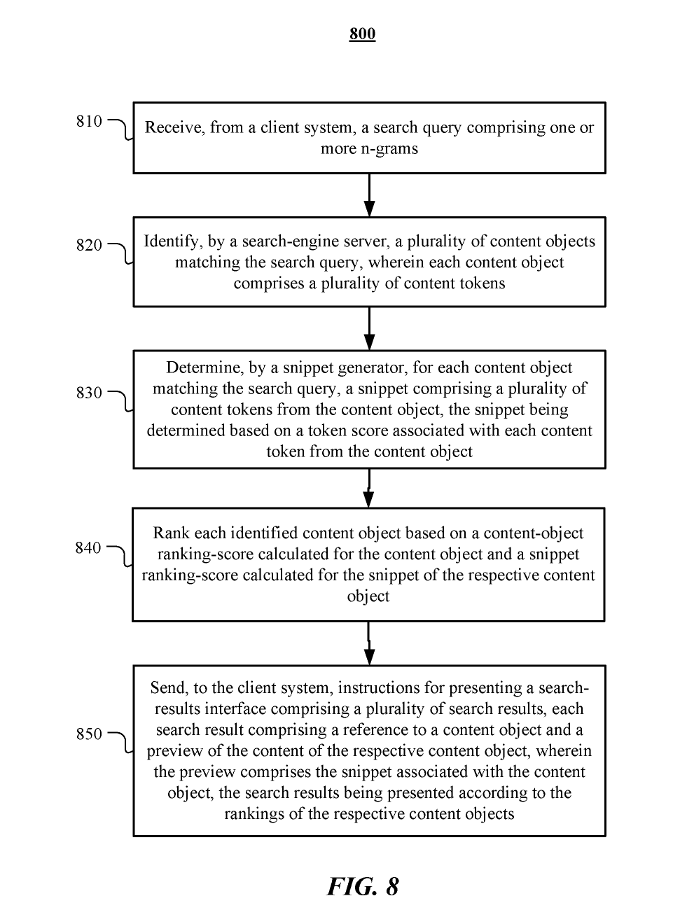

FIG. 8 illustrates an example method 800 for generating search results corresponding to content objects comprising snippets associated with each content object. The method may begin at step 810, where the social-networking system 160 may receive, from a client system 130, a search query comprising one or more n-grams. At step 820, the social-networking system 160 may identify, by a search-engine server 660, a plurality of content objects 410 matching the search query. Each content object 410 may comprise a plurality of content tokens. Each content token may be an n-gram corresponding to a word, user name, or concept name. At step 830, the social-networking system 160 may determine, by a snippet generator 400, for each content object 410 matching the search query, a snippet 450 comprising a plurality of content tokens from the content object 410. The snippet 450 may be determined based on a token score associated with each content token from the content object 410. The content tokens may be determined by a text tokenizer 420. The token score for each content token may be generated by a token-score generator 430. At step 840, the social-networking system 160 may rank each identified content object 410 based on a content-object ranking-score calculated for the content object 410 and a snippet ranking-score calculated for the snippet 450 of the respective content object 410. At step 850, the social-networking system 160 may send, to the client system 130, instructions for presenting a search-results interface comprising a plurality of search results, each search result comprising a reference to a content object 410 and a preview of the content of the respective content object. The preview may comprise the snippet 450 associated with the content object 410. The search results may be presented according to the rankings of the respective content objects 410. Particular embodiments may repeat one or more steps of the method of FIG. 8, where appropriate. Although this disclosure describes and illustrates particular steps of the method of FIG. 8 as occurring in a particular order, this disclosure contemplates any suitable steps of the method of FIG. 8 occurring in any suitable order. Moreover, although this disclosure describes and illustrates an example method for generating search results corresponding to content objects comprising snippets associated with each content object including the particular steps of the method of FIG. 8, this disclosure contemplates any suitable method for generating search results comprising snippets associated with each content object including any suitable steps, which may include all, some, or none of the steps of the method of FIG. 8, where appropriate. Furthermore, although this disclosure describes and illustrates particular components, devices, or systems carrying out particular steps of the method of FIG. 8, this disclosure contemplates any suitable combination of any suitable components, devices, or systems carrying out any suitable steps of the method of FIG. 8.

### Systems and Methods

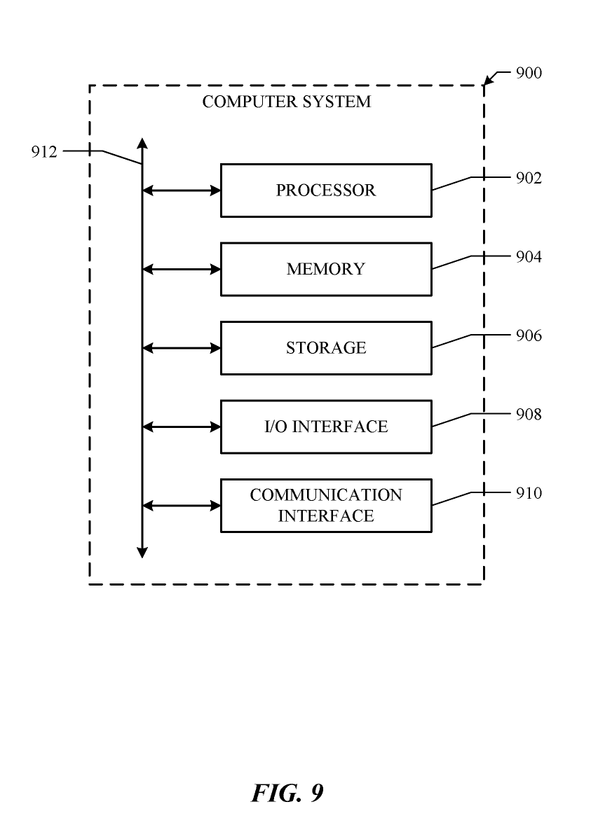

FIG. 9 illustrates an example computer system 900. In particular embodiments, one or more computer systems 900 perform one or more steps of one or more methods described or illustrated herein. In particular embodiments, one or more computer systems 900 provide functionality described or illustrated herein. In particular embodiments, software running on one or more computer systems 900 performs one or more steps of one or more methods described or illustrated herein or provides functionality described or illustrated herein. Particular embodiments include one or more portions of one or more computer systems 900. Herein, reference to a computer system may encompass a computing device, and vice versa, where appropriate. Moreover, reference to a computer system may encompass one or more computer systems, where appropriate.

This disclosure contemplates any suitable number of computer systems 900. This disclosure contemplates computer system 900 taking any suitable physical form. As example and not by way of limitation, computer system 900 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 900 may include one or more computer systems 900; be unitary or distributed; span multiple locations; span multiple machines; span multiple data centers; or reside in a cloud, which may include one or more cloud components in one or more networks. Where appropriate, one or more computer systems 900 may perform without substantial spatial or temporal limitation one or more steps of one or more methods described or illustrated herein. As an example and not by way of limitation, one or more computer systems 900 may perform in real time or in batch mode one or more steps of one or more methods described or illustrated herein. One or more computer systems 900 may perform at different times or at different locations one or more steps of one or more methods described or illustrated herein, where appropriate.

In particular embodiments, computer system 900 includes a processor 902, memory 904, storage 906, an input/output (I/O) interface 908, a communication interface 910, and a bus 912. Although this disclosure describes and illustrates a particular computer system having a particular number of particular components in a particular arrangement, this disclosure contemplates any suitable computer system having any suitable number of any suitable components in any suitable arrangement.

In particular embodiments, processor 902 includes hardware for executing instructions, such as those making up a computer program. As an example and not by way of limitation, to execute instructions, processor 902 may retrieve (or fetch) the instructions from an internal register, an internal cache, memory 904, or storage 906; decode and execute them; and then write one or more results to an internal register, an internal cache, memory 904, or storage 906. In particular embodiments, processor 902 may include one or more internal caches for data, instructions, or addresses. This disclosure contemplates processor 902 including any suitable number of any suitable internal caches, where appropriate. As an example and not by way of limitation, processor 902 may include one or more instruction caches, one or more data caches, and one or more translation lookaside buffers (TLBs). Instructions in the instruction caches may be copies of instructions in memory 904 or storage 906, and the instruction caches may speed up retrieval of those instructions by processor 902. Data in the data caches may be copies of data in memory 904 or storage 906 for instructions executing at processor 902 to operate on; the results of previous instructions executed at processor 902 for access by subsequent instructions executing at processor 902 or for writing to memory 904 or storage 906; or other suitable data. The data caches may speed up read or write operations by processor 902. The TLBs may speed up virtual-address translation for processor 902. In particular embodiments, processor 902 may include one or more internal registers for data, instructions, or addresses. This disclosure contemplates processor 902 including any suitable number of any suitable internal registers, where appropriate. Where appropriate, processor 902 may include one or more arithmetic logic units (ALUs); be a multi-core processor; or include one or more processors 902. Although this disclosure describes and illustrates a particular processor, this disclosure contemplates any suitable processor.

In particular embodiments, memory 904 includes main memory for storing instructions for processor 902 to execute or data for processor 902 to operate on. As an example and not by way of limitation, computer system 900 may load instructions from storage 906 or another source (such as, for example, another computer system 900) to memory 904. Processor 902 may then load the instructions from memory 904 to an internal register or internal cache. To execute the instructions, processor 902 may retrieve the instructions from the internal register or internal cache and decode them. During or after execution of the instructions, processor 902 may write one or more results (which may be intermediate or final results) to the internal register or internal cache. Processor 902 may then write one or more of those results to memory 904. In particular embodiments, processor 902 executes only instructions in one or more internal registers or internal caches or in memory 904 (as opposed to storage 906 or elsewhere) and operates only on data in one or more internal registers or internal caches or in memory 904 (as opposed to storage 906 or elsewhere). One or more memory buses (which may each include an address bus and a data bus) may couple processor 902 to memory 904. Bus 912 may include one or more memory buses, as described below. In particular embodiments, one or more memory management units (MMUs) reside between processor 902 and memory 904 and facilitate accesses to memory 904 requested by processor 902. In particular embodiments, memory 904 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 904 may include one or more memories 904, where appropriate. Although this disclosure describes and illustrates particular memory, this disclosure contemplates any suitable memory.

In particular embodiments, storage 906 includes mass storage for data or instructions. As an example and not by way of limitation, storage 906 may include a hard disk drive (HDD), a floppy disk drive, flash memory, an optical disc, a magneto-optical disc, magnetic tape, or a Universal Serial Bus (USB) drive or a combination of two or more of these. Storage 906 may include removable or non-removable (or fixed) media, where appropriate. Storage 906 may be internal or external to computer system 900, where appropriate. In particular embodiments, storage 906 is non-volatile, solid-state memory. In particular embodiments, storage 906 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 906 taking any suitable physical form. Storage 906 may include one or more storage control units facilitating communication between processor 902 and storage 906, where appropriate. Where appropriate, storage 906 may include one or more storages 906. Although this disclosure describes and illustrates particular storage, this disclosure contemplates any suitable storage.

In particular embodiments, I/O interface 908 includes hardware, software, or both, providing one or more interfaces for communication between computer system 900 and one or more I/O devices. Computer system 900 may include one or more of these I/O devices, where appropriate. One or more of these I/O devices may enable communication between a person and computer system 900. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 908 for them. Where appropriate, I/O interface 908 may include one or more device or software drivers enabling processor 902 to drive one or more of these I/O devices. I/O interface 908 may include one or more I/O interfaces 908, where appropriate. Although this disclosure describes and illustrates a particular I/O interface, this disclosure contemplates any suitable I/O interface.

In particular embodiments, communication interface 910 includes hardware, software, or both providing one or more interfaces for communication (such as, for example, packet-based communication) between computer system 900 and one or more other computer systems 900 or one or more networks. As an example and not by way of limitation, communication interface 910 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 910 for it. As an example and not by way of limitation, computer system 900 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 900 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 900 may include any suitable communication interface 910 for any of these networks, where appropriate. Communication interface 910 may include one or more communication interfaces 910, where appropriate. Although this disclosure describes and illustrates a particular communication interface, this disclosure contemplates any suitable communication interface.

In particular embodiments, bus 912 includes hardware, software, or both coupling components of computer system 900 to each other. As an example and not by way of limitation, bus 912 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 912 may include one or more buses 912, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

### Miscellaneous

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising, by one or more computing devices:
receiving, from a client system, a search query comprising one or more n-grams;
identifying, by a search-engine server, a plurality of content objects matching the search query, wherein each content object comprises a plurality of content tokens;
determining, by a snippet generator, for each content object matching the search query, a snippet comprising a plurality of content tokens from the content object, the snippet being determined based on a token score associated with each content token from the content object;
ranking each identified content object based on a content-object ranking-score calculated for the content object and a snippet ranking-score calculated for the snippet of the respective content object; and
sending, to the client system, instructions for presenting a search-results interface comprising a plurality of search results, each search result comprising a reference to a content object and a preview of the content of the respective content object, wherein the preview comprises the snippet associated with the content object, the search results being presented according to the rankings of the respective content objects.

2. The method of claim 1, wherein each content token is an n-gram, and wherein each content token corresponds to a word, a user name, or a concept name.

3. The method of claim 1, further comprising:
determining, by a token-score generator, a token score for each content token of the plurality of content tokens from each content object, wherein the token score is based on one or more positive factors or one or more negative factors.

4. The method of claim 3, wherein the one or more positive factors of the token score for each content token comprise one or more of:
a measure of similarity between the content token and one or more n-grams of the search query;
a measure of similarity between the content token and one or more trending topics; or
a measure of a likelihood that the content token is an opinion-related content token.

5. The method of claim 3, wherein the one or more negative factors of the token score for each content token comprise one or more of:
a measure of offensiveness of the content token; or
a measure of a likelihood of the content token being misspelled.

6. The method of claim 1, wherein the snippet generator comprises a snippet-candidate generator, the method further comprising:
generating, by the snippet-candidate generator, a plurality of snippet candidates for each content object based on one or more snippet-candidate constraints that specify criteria for selecting content tokens for the snippet, each snippet candidate comprising a plurality of content tokens from the content object that satisfy the criteria specified in the one or more snipped-candidate constraints.

7. The method of claim 6, wherein the snippet-candidate constraints comprise one or more of:
a maximum number of content tokens of the snippet candidate;
a maximum length of the snippet candidate; or
a measure of contiguity of the content tokens of the snippet candidate.

8. The method of claim 6, wherein the snippet generator further comprises a snippet-candidate scorer, the method further comprising:
determining, by the snippet-candidate scorer, a candidate score for each snippet candidate, the candidate score being determined based on the token score associated with each content token of the snippet candidate; and
selecting, by the snippet generator, from the plurality of snippet candidates for each content object, the snippet for the content object based on the determined snippet-candidate scores of the snippet candidates.

9. The method of claim 1, wherein the content-object ranking-score is based on one or more content-object-ranking factors, the content-object-ranking factors comprising one or more of:
a measure of relevance of the content object to the search query;
a measure of relevance of an author of the content object to the search query; or
a measure of relevance of the author of the content object to a user of the client system.

10. The method of claim 1, wherein the snippet ranking-score is based on one or more snippet-ranking factors, the snippet-ranking factors comprising one or more of:
one or more textual properties of the snippet;
one or more query-related characteristics of the snippet; or
a search history associated with the snippet.

11. The method of claim 1, wherein the content objects are posts comprising text, and wherein each snippet comprises a text segment extracted from the text of the respective post.

12. The method of claim 1, wherein the content objects are web pages, and wherein each snippet comprises a text segment extracted from the text of the respective web page.

13. The method of claim 1, wherein determining the snippet based on the token score associated with each content token from the content object comprises determining a total token score of the snippet based on an algorithm comprising:
$${argmax}_{u , v} W = {\sum }_{k = 1}^{K} {\sum }_{i = {u}_{k}}^{{v}_{k}} S ( i ) ,$$
wherein
W is the total token score of the snippet;
N is a number of content tokens of the content object;
M is a number of content tokens for the snippet;
u, v are a start position and end position, respectively, of content tokens for each content object T(u, v)=1, . . . u, . . . v, . . . N;
S(i) is a token score for the content token i; and
K is a number of partitions permitted in each snippet candidate.

14. The method of claim 13, wherein the number of partitions permitted in each snippet candidate, K, is 1, and the algorithm further comprises:
$$W ( i ) = \{ \begin{matrix}{\sum }_{j = 1}^{i} S ( j ) , 1 \leq i \leq N \\ 0 , i = 0\end{matrix} ; \\ u = {argmax}_{i} W ( i + M - 1 ) - W ( i ) , 1 \leq i \leq N - M + 1 ; and \\ v = u + M - 1.$$

15. The method of claim 13, wherein the number of partitions permitted in each snippet, K, is greater than 1, and the algorithm further comprises:
$$w ( i ) = \{ \begin{matrix}{\sum }_{j = 1}^{i} S ( j ) , 1 \leq i \leq N \\ 0 , i = 0\end{matrix} is a total token score of the snippet ;$$
L(j) is a length of a jth snippet partition;
$$V ( k ) = \{ \begin{matrix}{\sum }_{j = 1}^{k} L ( j ) , 1 \leq k \leq K \\ 0 , k = 0\end{matrix} is a total length of the snippet ; \\ B ( k , i ) = \{ \begin{matrix}\begin{matrix}argmax \{ B ( k - 1 , j ) + W ( i ) - W ( i - L ( k ) ) \} , 1 \leq k \leq K , \\ V ( k ) \leq i \leq N , V ( k - 1 ) \leq j \leq i - L ( k )\end{matrix} \\ 0 , k = 0 \\ 0 , i = 0 \\ 0 , i < V ( k )\end{matrix}$$
is a maximum token score sum of i partitions;
$${v}_{k} = \{ \begin{matrix}{argmax}_{i} B ( k , i ) , V ( k ) \leq i \leq N , k + K \\ {argmax}_{i} B ( k , i ) , V ( k ) \leq i \leq {u}_{k + 1} , 1 \leq k \leq K\end{matrix} ; and \\ {u}_{k} = {v}_{k} + L ( k ) + 1 , 1 \leq k \leq K .$$

16. The method of claim 1, wherein the token score, content-object ranking-score, snippet ranking-score, or ranking is determined according to a formula comprising one or more weights applied to one or more constituent scores, respectively, the weights having values determined by one or more machine-learning processes.

17. One or more computer-readable non-transitory storage media embodying software that is operable when executed to:
receive, from a client system, a search query comprising one or more n-grams;
identify, by a search-engine server, a plurality of content objects matching the search query, wherein each content object comprises a plurality of content tokens;
determine, by a snippet generator, for each content object matching the search query, a snippet comprising a plurality of content tokens from the content object, the snippet being determined based on a token score associated with each content token from the content object;
rank each identified content object based on a content-object ranking-score calculated for the content object and a snippet ranking-score calculated for the snippet of the respective content object; and
send, to the client system, instructions for presenting a search-results interface comprising a plurality of search results, each search result comprising a reference to a content object and a preview of the content of the respective content object, wherein the preview comprises the snippet associated with the content object, the search results being presented according to the rankings of the respective content objects.

18. A system comprising: one or more processors; and a non-transitory memory coupled to the processors comprising instructions executable by the processors, the processors operable when executing the instructions to:
receive, from a client system, a search query comprising one or more n-grams;
identify, by a search-engine server, a plurality of content objects matching the search query, wherein each content object comprises a plurality of content tokens;
determine, by a snippet generator, for each content object matching the search query, a snippet comprising a plurality of content tokens from the content object, the snippet being determined based on a token score associated with each content token from the content object;
rank each identified content object based on a content-object ranking-score calculated for the content object and a snippet ranking-score calculated for the snippet of the respective content object; and
send, to the client system, instructions for presenting a search-results interface comprising a plurality of search results, each search result comprising a reference to a content object and a preview of the content of the respective content object, wherein the preview comprises the snippet associated with the content object, the search results being presented according to the rankings of the respective content objects.
